(19) United States
(12) Patent Application Publication
(10) Pub. No.: US 2015/0010731 A1
(43) Pub. Date: Jan. 8, 2015

(54) ANTIFOULING LAYER, ANTIFOULING SUBSTRATE, DISPLAY DEVICE, AND INPUT DEVICE

(71) Applicants: Ryosuke Iwata, Tokyo (JP); Mikihisa Mizuno, Tokyo (JP)

(72) Inventors: Ryosuke Iwata, Tokyo (JP); Mikihisa Mizuno, Tokyo (JP)

(73) Assignee: DEXERIALS CORPORATION, Tokyo (JP)

(21) Appl. No.: 14/380,422

(22) PCT Filed: Sep. 10, 2012
(86) PCT No.: PCT/JP2012/073758

§ 371 Date: Aug. 22, 2014

(30) Foreign Application Priority Data
Feb. 22, 2012 (JP) 2012-036856

(51) Int. Cl. C09D 5/16; B08B 17/06

(52) U.S. Cl. CPC C09D 5/1625; B08B 17/06; C09D 5/1693; C09D 5/1681
USPC 428/141; 106/287.24; 106/287.13; 524/315

(57) ABSTRACT

An antifouling substrate includes a substrate having a surface and an antifouling layer provided on the surface of the substrate. The antifouling layer contains at least one of a first compound having an ester linkage in a portion other than terminal ends and a second compound having a cyclic hydrocarbon group. The advancing contact angle of oleic acid on the surface of the antifouling layer is 15° or less, and the receding contact angle of oleic acid on the surface of the antifouling layer is 10° or less.

### TECHNICAL FIELD

The present technique relates to an antifouling layer, to an antifouling substrate, to a display device, and to an input device. Particularly, the present technique relates to an antifouling layer that suppresses smudges on a surface.

### BACKGROUND ART

In recent years, information display devices equipped with a touch panel as a user interface (UI) are rapidly becoming widespread. A touch panel has an advantage in that the user can operate the device intuitively by directly touching the display screen with a finger. However, a problem with the touch panel is that fingerprints adhering to the display screen deteriorate the visibility of the display screen. Therefore, there is a demand for a fingerprint resistant surface on which fingerprints adhering thereto are less noticeable.

An antifouling layer designed such that a fluorine-based compound or a silicon-based compound is present on the outermost surface has been used for a display surface including a touch panel (see, for example, Patent Literature 1). This is because the formation of the water-repellent and oil-repellent surface has an effect in that the adhesion of oil and fat components forming fingerprints is weakened, so that the fingerprints can be easily wiped off with, for example, a cloth. However, there is a problem in that, unless the fingerprints are wiped off with, for example, a cloth, the oil and fat components are repelled by the layer surface to form droplets that cause light scattering. As a result, a problem in that the fingerprints become noticeable arises.

To address this problem, a water-repellent oleophilic surface that does not repel oil and fat components has been proposed (see, for example, Patent Literature 2). The oil and fat components of fingerprints adhering to this surface spread and do not form droplets, so that the fingerprints are less noticeable. However, since the patterns of the fingerprints remain present, light scattering caused by the fingerprint patterns occurs, and the adhering fingerprints are visible unless the fingerprints are wiped off with a cloth etc. When fingerprints adhere successively, these fingerprints become noticeable eventually.

### CITATION LIST

### Patent Literature

Patent Literature 1: Japanese Patent No. 04666667
Patent Literature 2: Japanese Patent Application Laid-Open No. 2010-128363

### SUMMARY OF INVENTION

### Technical Problem

As described above, there is a demand for a surface that allows fingerprints adhering thereto to be less noticeable. However, in consideration of applications such as capacitive touch panels, a surface from which fingerprints can be wiped off with a finger (i.e., a surface in which fingerprints become less noticeable with use over time) is considered to be important. However, techniques for improving ease of wiping off fingerprints with a finger have not been investigated.

Accordingly, it is an object of the present technique to provide an antifouling layer, an antifouling substrate, a display device, and an input device in which the ease of wiping off fingerprints with, for example, a finger can be improved.

### Solution to Problem

To solve the foregoing problems, a first technique is an antifouling substrate, including

a substrate having a surface, and

an antifouling layer provided on the surface of the substrate, wherein

the antifouling layer contains at least one of a first compound having an ester linkage in a portion other than terminal ends and a second compound having a cyclic hydrocarbon group,

the at least one of the first compound and the second compound is adsorbed on the surface of the substrate,

an advancing contact angle of oleic acid on a surface of the antifouling layer is 15° or less, and

a receding contact angle of oleic acid on the surface of the antifouling layer is 10° or less.

A second technique is an antifouling substrate, including

a substrate having a surface, and

an antifouling layer provided on the surface of the substrate, wherein

the antifouling layer contains at least one of a first compound having an ester linkage in a portion other than terminal ends and a second compound having a cyclic hydrocarbon group,

the first compound is represented by the formula (1) or (2) below,

the second compound is represented by the formula (3) or (4) below,

an advancing contact angle of oleic acid on a surface of the antifouling layer is 15° or less, and

a receding contact angle of oleic acid on the surface of the antifouling layer is 10° or less,

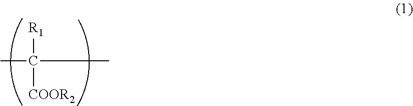

wherein, in the formula (1), R₁ is a group containing any of C, N, S, O, Si, P, and Ti, and R₂ is a group having 2 or more carbon atoms,

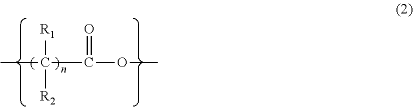

wherein, in the formula (2), R₁ and R₂ are each independently a group containing any of C, N, S, O, Si P, and Ti.

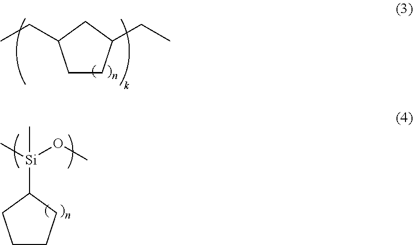

A third technique is an antifouling substrate, including

a substrate having a surface, and

an antifouling layer provided on the surface of the substrate, wherein

the antifouling layer contains at least one of a first compound having an ester linkage in a portion other than terminal ends and a second compound having a cyclic hydrocarbon group,

when the antifouling layer contains the second compound, the antifouling layer further contains, together with the second compound, a third compound having a chain hydrocarbon group at a terminal end,

the third compound is represented by the formula (5) or (6) below,

an advancing contact angle of oleic acid on a surface of the antifouling layer is 15° or less, and

a receding contact angle of oleic acid on the surface of the antifouling layer is 10° or less,

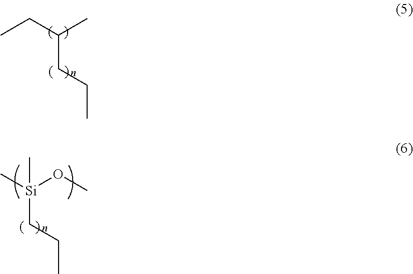

A fourth technique is an antifouling layer, including

at least one of a first compound having an ester linkage in a portion other than terminal ends and a second compound having a cyclic hydrocarbon group, wherein

the at least one of the first compound and the second compound is adsorbed on a surface of a substrate,

an advancing contact angle of oleic acid on a surface of the antifouling layer is 15° or less, and

a receding contact angle of oleic acid on the surface of the antifouling layer is 10° or less.

A fifth technique is an antifouling layer, including

at least one of a first compound having an ester linkage in a portion other than terminal ends and a second compound having a cyclic hydrocarbon group, wherein

the first compound is represented by the formula (1) or (2) below,

the second compound is represented by the formula (3) or (4) below,

an advancing contact angle of oleic acid on a surface of the antifouling layer is 15° or less, and

a receding contact angle of oleic acid on the surface of the antifouling layer is 10° or less,

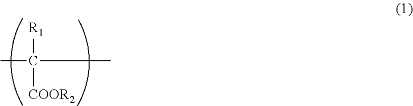

wherein, in the formula (1), R₁ is a group containing any of C, N, S, O, Si, P, and Ti, and R₂ is a group having 2 or more carbon atoms,

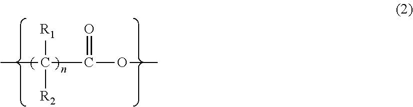

wherein, in the formula (2), R₁ and R₂ are each independently a group containing any of C, N, S, O, P, and Ti.

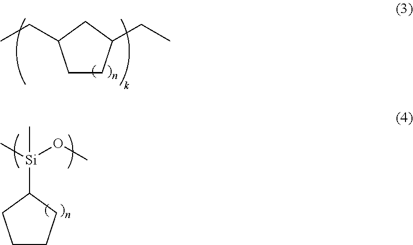

A sixth technique is an antifouling layer, including

at least one of a first compound having an ester linkage in a portion other than terminal ends and a second compound having a cyclic hydrocarbon group, wherein,

when the antifouling layer contains the second compound, the antifouling layer further includes, together with the second compound, a third compound having a chain hydrocarbon group at a terminal end,

the third compound is represented by the formula (5) or (6) below,

an advancing contact angle of oleic acid on a surface of the antifouling layer is 15° or less, and

a receding contact angle of oleic acid on the surface of the antifouling layer is 10° or less

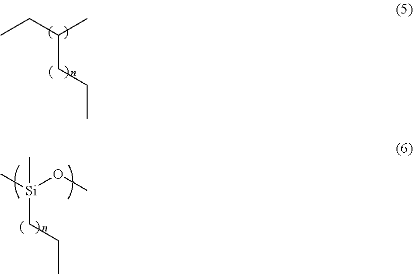

In the present technique, the advancing contact angle of oleic acid on an input surface, a display surface, or a surface of the antifouling layer 15° or less, and the receding contact angle of oleic acid is 10° or less. Therefore, fingerprints adhering to the input surface, the display surface, or the surface can be made less noticeable by rubbing the fingerprints with, for example, a finger to spread them thinly.

### Advantageous Effects of Invention

According to the present technique, the ease of wiping off fingerprints with a finger etc. can be improved, as described above.

### BRIEF DESCRIPTION OF DRAWINGS

FIG. 1 is a cross-sectional view illustrating an example of a configuration of an antifouling substrate according to a first embodiment of the present technique.

FIG. 2 is a schematic diagram for explaining an advancing contact angle and a receding contact angle measured by a sliding method.

FIG. 3 is a cross-sectional view illustrating an example of a configuration of an antifouling substrate according to a first modification.

FIG. 4 is a cross-sectional view illustrating an example of a configuration of an antifouling substrate according to a second modification.

FIG. 5 is a cross-sectional view illustrating an example of a configuration of an antifouling substrate according to a third modification.

FIG. 6 is a cross-sectional view illustrating an example of a configuration of an antifouling substrate according to a fourth modification.

FIG. 7 is a cross-sectional view illustrating an example of a configuration of an antifouling substrate according to a fifth modification.

FIGS. 8A to 8C are schematic diagrams illustrating examples of configurations of an antifouling substrate according to a second embodiment of the present technique.

FIG. 9A is a cross-sectional view illustrating an example of a configuration of an antifouling substrate according to a third embodiment of the present technique.

FIG. 9B is a plan view illustrating the example of the configuration of the antifouling substrate according to the third embodiment of the present technique.

FIG. 10A is a schematic diagram for explaining directions of capillary pressure on a fingerprint resistant surface. FIG. 10B is a schematic diagram for explaining capillarity on an uneven surface. FIG. 10C is a schematic diagram for explaining a contact angle on an uneven surface.

FIG. 11 is a cross-sectional view illustrating an example of a configuration of an antifouling substrate according to a modification.

FIG. 12 is an exploded perspective view illustrating an example of a configuration of a display device according to a fourth embodiment of the present technique.

FIG. 13A is an exploded perspective view illustrating an example of a configuration of an input device according to a fifth embodiment of the present technique. FIG. 13B is an exploded perspective view illustrating an example of a configuration of a modification of the input device according to the fifth embodiment of the present technique.

FIGS. 14A and 14B are diagrams showing the results of evaluation of the surface shape of an antifouling film in Example 13.

### DESCRIPTION OF EMBODIMENTS

Embodiments of the present technique will be described in the following order.

1. First embodiment (an example of an antifouling substrate having a fingerprint resistant surface)

2. Second embodiment (an example of an antifouling substrate having a fingerprint resistant surface)

3. Third embodiment (an example of an antifouling substrate having a fingerprint resistant surface)

4. Fourth embodiment (an example of a display device having a fingerprint resistant surface)

5. Fifth embodiment (an example of an input device having a fingerprint resistant surface)

### 1. First Embodiment

### Configuration of Antifouling Substrate

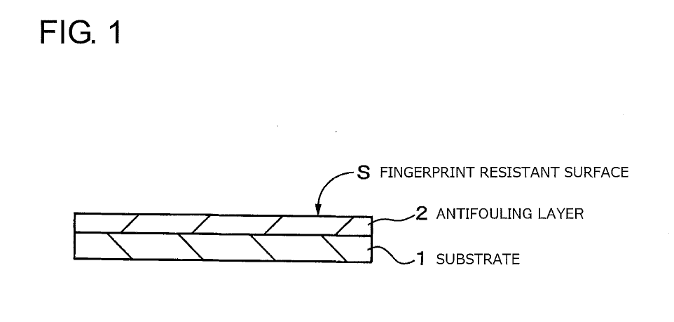

FIG. 1 is a cross-sectional view illustrating an example of a configuration of an antifouling substrate according to the first embodiment of the present technique. As shown in FIG. 1, this antifouling substrate includes a substrate 1 and an antifouling layer 2 provided on one of the principal surfaces of the substrate 1. The antifouling substrate has a fingerprint resistant surface (antifouling surface) S on the side on which the antifouling layer 2 is disposed. The antifouling substrate according to the first embodiment is suitably applied to the display surface of a display device, the input surface of an input device, the surface of a casing, etc. It is also preferable that the antifouling layer 2 be directly applied to the surface of any of the above devices without the substrate 1. Examples of the display device to which the antifouling substrate or the antifouling layer 2 is applied to the display surface may include, but are not limited to, television sets, personal computers (PCs), mobile devices (such as smart phones and slate PCs), and photo frames. The input device to which the antifouling substrate or the antifouling layer 2 is applied to the input surface is preferably an input device having an input unit that is touched with a hand and a finger. Examples of such an input device may include, but are not limited to, touch panels, mice, and keyboards. Examples of the touch panel may include, but are not limited to, touch panels provided in television sets, personal computers, mobile devices (such as smart phones and slate PCs), and photo frames. Examples of the casing to which the antifouling substrate or the antifouling layer 2 is applied may include, but are not limited to, casings of television sets, personal computers, mobile devices (such as smart phones and slate PCs), and photo frames.

Articles to which the antifouling substrate or the antifouling layer 2 is applied are not limited to the electronic devices and casings described above, and the antifouling substrate and the antifouling layer 2 can be suitable applied to any article having a surface that is touched with a hand or a finger. Examples of the articles other than the electronic devices and casings described above may include, but are not limited to, the outermost surfaces of paper, plastic, and glass articles (more specifically, for example, the outermost surfaces of photographs, photograph stands, plastic cases, glass windows, picture frames, etc.).

The advancing contact angle of oleic acid on the fingerprint resistant surface S is 15° or less, and the receding contact angle of oleic acid is 10° or less. In this case, fingerprints adhering to the fingerprint resistant surface S can be thinly spread by rubbing them with a finger, and it is possible to make the fingerprints less noticeable. Therefore, when the antifouling substrate or the antifouling layer 2 is applied to an input device or a display device, fingerprints can become less noticeable with use over time. The advancing contact angle and the receding contact angle are dynamic contact angles of oleic acid and are measured by a sliding method (measurement on a slope). The sliding method is a method in which a solid specimen having a liquid droplet placed thereon is inclined to allow the liquid droplet to slide.

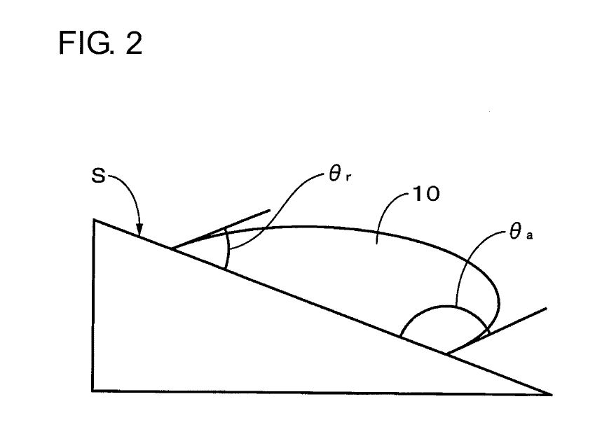

FIG. 2 is a schematic diagram for explaining the advancing contact angle and receding contact angle measured by the sliding method. As shown in FIG. 2, the advancing contact angle θa and the receding contact angle θr are the advancing contact angle and receding contact angle at which, when a fingerprint resistant surface S with a liquid droplet 10 of oleic acid placed thereon is inclined, the liquid droplet 10 starts sliding. The advancing contact angle θa is a contact angle on the side toward which the liquid droplet 10 spreads (the side toward which the liquid droplet advances). The receding contact angle θr is a contact angle on the side on which the liquid droplet 10 contracts (the side opposite to the side toward which the liquid droplet advances).

Oleic acid is one of the components forming a fingerprint, and the dynamic contact angles of oleic acid are considered to quantitatively represent the degree of spread on the surface of a material when the fingerprint is rubbed with a finger. Therefore, it is conceivable that, on a surface on which the dynamic contact angles of oleic acid are equal to or less than the above prescribed values, fingerprints can be made less noticeable by rubbing them with a finger to spread them thinly.

### (Substrate)

The substrate 1 is, for example, a transparent inorganic substrate or a transparent plastic substrate. The shape of the substrate 1 used may be, for example, a film shape, a sheet shape, a plate shape, or a block shape. Examples of the material of the inorganic substrate may include quartz, sapphire, and glass. Any known macromolecular material can be used as the material of the plastic substrate. Specific examples of the known macromolecular material may include triacetylcellulose (TAC), polyester (TPEE), polyethylene terephthalate (PET), polyethylene naphthalate (PEN), polyimide (PI), polyamide (PA), aramid, polyethylene (PE), polyacrylate, polyether sulfone, polysulfone, polypropylene (PP), diacetylcellulose, polyvinyl chloride, acrylic resin (PMMA), polycarbonate (PC), epoxy resin, urea resin, urethane resin, melamine resin, and cycloolefin polymers (COPs).

The substrate 1 may be processed into part of the exterior or display of an electronic device etc. The surface shape of the substrate 1 is not limited to a flat shape, and the substrate 1 may have an uneven surface, a polygonal surface, a curved surface, or a combination thereof. Examples of the curved surface may include a spherical surface, an elliptic surface, a parabolic surface, and a free-form surface. A prescribed structure may be provided on the surface of the substrate 1 by, for example, UV transfer, thermal transfer, pressure transfer, melt extrusion, etc.

### (Antifouling Layer)

The antifouling layer 2 is a modified surface layer containing at least one of a first compound having an ester linkage in a portion other than terminal ends and a second compound having a cyclic hydrocarbon group. Since the antifouling layer 2 contains at least one of the first compound and the second compound, the ease of wiping off fingerprints can be improved. The above terminal ends are terminal ends of the main and side chains. The antifouling layer 2 is a coating layer formed by, for example, a wet process or a dry process.

When the antifouling layer 2 contains the second compound, it is preferable that the antifouling layer 2 further contain, together with the second compound, third compound having a chain hydrocarbon group at its terminal end. In this case, the ease of wiping off fingerprints can be further improved. The above terminal end is a terminal end of any of the main and side chains. No particular limitation is imposed on the contents of the second and third compounds in the antifouling layer 2. However, since the third compound has the property of gathering on the fingerprint resistant surface S relatively easily, it is preferable that the contents be selected in consideration of this property.

If necessary, the antifouling layer 2 may further contain additives such as a polymerization initiator, a light stabilizer, an ultraviolet absorber, a catalyst, a coloring agent, an antistatic agent, a lubricant, a leveling agent, an antifoaming agent, a polymerization promoter, an antioxidant, a flame retardant, an infrared absorber, a surfactant, a surface modifier, and a thixotropic agent. The antifouling layer 2 may further contain light-scattering particles such as an organic resin filler that scatter light, in order to impart an AG (Anti-Glare) function to the fingerprint resistant surface S. When the AG function is imparted, the light-scattering particles may protrude from the fingerprint resistant surface S of the antifouling layer 2 or may be covered with, for example, a resin contained in the antifouling layer 2. The light-scattering particles may or may not be in contact with the substrate 1, which is a lower layer. The average thickness of the antifouling layer 2 is within the range of, for example, a monomolecular thickness or more and 1 mm or less, preferably a monomolecular thickness or more and 100 μm or less, and particularly preferably a monomolecular thickness or more and 10 μm or less.

The first compound and/or the second compound is, for example, at least one of main and accessory components of the material constituting the antifouling layer 2. When the antifouling layer 2 is a layer formed by a wet process, the main component is, for example, a base resin, and the accessory component is, for example, an additive such as the leveling agent described above. Preferably, the first, second and third compounds are additives. This is because, for example, deterioration of hardness of the base resin can be suppressed. When any of these compounds is an additive as described above, it is preferable that the additive be a leveling agent. When the first, second and third compounds are additives such as a leveling agent, it is preferable that the first, second, and third compounds be bonded to the base resin through, for example, a polymerization reaction. This is because the durability of the fingerprint resistant surface S can be improved.

### (First Compound)

The first compound may be an organic material, an organic-inorganic composite material, a macromolecular material, or a monomolecular material, so long as the first compound has an ester linkage in a portion other than terminal ends. No particular limitation is imposed on the molecular structure of the first compound so long as it has an ester linkage, and the first compound may have any functional group, any bonding site, any hetero atom, any halogen atom, any metal atom, etc. The first compound used may be, for example, a compound having, in its molecule, a structure represented by the formula (1) or (2) below.

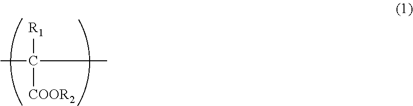

In the formula (1), R₁ is a group containing an atom such as any of C, N, S, O, Si, P, and Ti. The group containing such an atom is, for example, a hydrocarbon group, a sulfo group (including a sulfonate group), a sulfonyl group, a sulfonamide group, a carboxylic acid group (including a carboxylate group), an amino group, an amide group, a phosphoric acid group (including a phosphate group and a phosphoric ester group), a phosphino group, a silanol group, an epoxy group, an isocyanate group, a cyano group, a thiol group, or a hydroxyl group. R₂ is a group having at least 2 carbon atoms and is, for example, a group containing an atom such as any of C, N, S, O, Si, P, and Ti. The group containing such an atom is, for example, a hydrocarbon group, a sulfo group (including a sulfonate group), a sulfonyl group, a sulfonamide group, a carboxylic acid group (including a carboxylate group), an amino group, an amide group, a phosphoric acid group (including a phosphate group and a phosphoric ester group), a phosphino group, a silanol group, an epoxy group, an isocyanate group, a cyano group, a thiol group, or a hydroxyl group.

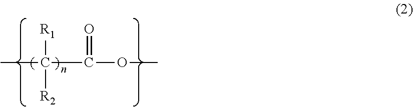

In the formula (2), R₁ and R₂ are each independently a group containing an atom such as any of C, N, S, O, Si, P, and Ti. The group containing such an atom is, for example, a hydrocarbon group, a sulfo group (including a sulfonate group), a sulfonyl group, a sulfonamide group, a carboxylic acid group (including a carboxylate group), an amino group, an amide group, a phosphoric acid group (including a phosphate group and a phosphoric ester group), a phosphino group, a silanol group, an epoxy group, an isocyanate group, a cyano group, a thiol group, or a hydroxyl group.

### (Second Compound)

The second compound has a cyclic hydrocarbon group. The cyclic hydrocarbon group may be, for example, an unsaturated cyclic hydrocarbon group or a saturated cyclic hydrocarbon group and may have, in its molecule, both an unsaturated cyclic hydrocarbon group and a saturated cyclic hydrocarbon group. The antifouling layer 2 may contain a second compound having an unsaturated cyclic hydrocarbon group and a second compound having a saturated cyclic hydrocarbon group. The cyclic hydrocarbon group may be any of a monocyclic hydrocarbon group and a polycyclic hydrocarbon group. The cyclic hydrocarbon group may have an additional substituent. Examples of the additional substituent may include a hydrocarbon group, a sulfo group (including a sulfonate group), a sulfonyl group, a sulfonamide group, a carboxylic acid group (including a carboxylate group), an amino group, an amide group, a phosphoric acid group (including a phosphate group and a phosphoric ester group), a phosphino group, a silanol group, an epoxy group, an isocyanate group, a cyano group, a thiol group, and a hydroxyl group. The second compound may be an organic material, an organic-inorganic composite material, a macromolecular material, or a monomolecular material, so long as the second compound has a cyclic hydrocarbon group. No particular limitation is imposed on the molecular structure of the second compound so long as it has a cyclic hydrocarbon group, and the second compound may have any functional group, any bonding site, any hetero atom, any halogen atom, any metal atom, etc. Examples of the saturated cyclic hydrocarbon group may include groups having five or more carbon atoms and having monocyclo, bicyclo, tricyclo, and tetracyclo structures and similar structures. More specific examples thereof may include a cyclopentyl group, a cyclohexyl group, a cycloheptyl group, a cyclooctyl group, a cyclononyl group, a cyclodecyl group, a cyclododecyl group, an adamantyl group, a noradamantyl group, a tricyclodecyl group, a tetracyclododecyl group, a norbornyl group, an isobornyl group, and a steroid group. Examples of the unsaturated cyclic hydrocarbon group may include a phenyl group, a naphthyl group, a pyrenyl group, a pentacenyl group, and an anthryl group.

For example, a compound having, in its molecule, a structure represented by the formula (3) below may be used as the organic material.

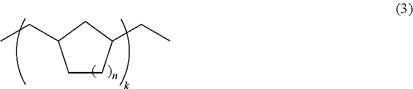

For example, a compound having, in its molecule, a structure represented by the formula (4) below may be used as the organic-inorganic composite material.

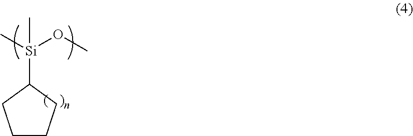

### (Third Compound)

The third compound has a chain hydrocarbon group (an acyclic hydrocarbon group) at its terminal end. The chain hydrocarbon group is, for example, any of an unsaturated chain hydrocarbon group and a saturated chain hydrocarbon group, and the third compound may contain, in its molecule, both an unsaturated chain hydrocarbon group and a saturated chain hydrocarbon group. The chain hydrocarbon group may be a linear chain hydrocarbon group or a branched chain hydrocarbon group, and the third compound may contain, in its molecule, both a linear chain hydrocarbon group and a branched chain hydrocarbon group. The chain hydrocarbon group may have an additional substituent. Examples of the additional substituent may include a hydrocarbon group, a sulfo group (including a sulfonate group), a sulfonyl group, a sulfonamide group, a carboxylic acid group (including a carboxylate group), an amino group, an amide group, a phosphoric acid group (including a phosphate group and a phosphoric ester group), a phosphino group, a silanol group, an epoxy group, an isocyanate group, a cyano group, a thiol group, and a hydroxyl group.

Any of an organic material, an organic-inorganic composite material, a macromolecular material, and a monomolecular material may be used as the third compound, so long as it is a compound having a chain hydrocarbon group at its terminal end. No particular limitation is imposed on the molecular structure of the third compound so long as it has a chain hydrocarbon group at its terminal end, and the third compound may have any functional group, any bonding site, any hetero atom, any halogen atom, any metal atom, etc. Examples of the unsaturated chain hydrocarbon group may include unsaturated chain hydrocarbon groups having at least 2 carbon atoms. Specific examples thereof may include a propene group, a butene group, a pentene group, a hexene group, a heptene group, an octene group, a decene group, a dodecene group, a tetradecane group, a hexadecene group, an octadecene group, and a docosene group. Examples of the saturated chain hydrocarbon group may include saturated chain hydrocarbon groups having at least 2 carbon atoms. More specific examples thereof may include an ethyl group, a propyl group, an isopropyl group, a butyl group, an isobutyl group, a pentyl group, an isopentyl group, a hexyl group, an isohexyl group, a heptyl group, an isoheptyl group, an octyl group, an isooctyl group, a nonyl group, an isononyl group, a decyl group, an isodecyl group, a dodecyl group, an isododecyl group, a lauryl group, a tridecyl group, an isotridecyl group, a myristyl group, an isomyristyl group, a cetyl group, an isocetyl group, a stearyl group, an isostearyl group, an arachidyl group, an isoarachidyl group, a behenyl group, an isobehenyl group, and a cholesterol group.

For example, a compound having, in its molecule, a structure represented by the formula (5) below may be used as the organic material.

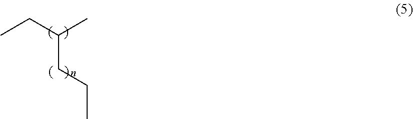

For example, a compound having, in its molecule, a structure represented by the formula (6) below may be used as the organic-inorganic composite material.

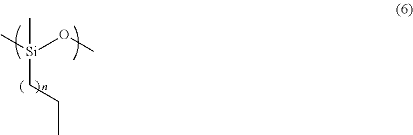

### (Method of Examining Fingerprint Resistant Surface)

Whether or not the antifouling substrate has a fingerprint resistant surface S can be examined, for example, as follows. First, dynamic contact angles on the surface of the antifouling substrate are measured to examine whether or not the advancing contact angle of oleic acid is in the range of 15° or less and the receding contact angle of oleic acid is in the range of 10° or less. Then, when the advancing contact angle of oleic acid and the receding contact angle of oleic acid are within the above ranges, it can be judged that the antifouling substrate has a fingerprint resistant surface S.

The following examination is also possible.

First, the material of the surface of the antifouling substrate is extracted with a solvent and subjected to composition analysis by Gas Chromatograph-Mass Spectrometry (GC-MASS). When at least one of the first and second compounds described above is detected, it can be judged that the antifouling substrate has a fingerprint resistant surface S.

A combination of the two examination methods described above may be used to examine whether or not the antifouling substrate has a fingerprint resistant surface S.

### [Method of Producing Antifouling Substrate]

A description will next be given of an example of a method of producing the antifouling substrate using a wet process.

### (Preparation of Resin Composition)

First, a resin component is dissolved in a solvent to prepare a resin composition. The solvent used may be water or an organic solvent. The resin composition contains, as a main component, at least one of an energy ray-curable resin composition and a thermosetting resin composition.

The energy ray-curable resin composition means a resin composition that can be cured by irradiation with energy rays. The energy rays are those that can trigger a polymerization reaction of radicals, cations, anions etc. and are energy rays such as an electron beam, ultraviolet rays, infrared rays, a laser beam, visible light, ionizing radiation (X-rays, α rays, β rays, γ rays etc.), microwaves, or high-frequency waves. If necessary, the energy ray-curable resin composition used may be mixed with another resin composition and, for example, may be mixed with another curable resin composition such as a thermosetting resin composition. The energy ray-curable resin composition may be an organic-inorganic hybrid material. A mixture of two or more types of energy ray-curable resin compositions may be used. Preferably, the energy ray-curable resin composition used is an ultraviolet ray-curable resin composition that is cured by irradiation with ultraviolet rays.

The energy ray-curable resin composition and the thermosetting resin contain at least one of the first compound having an ester linkage in a portion other than terminal ends and the second compound having a cyclic hydrocarbon group. Preferably, from the viewpoint of improving the ease of wiping off fingerprints, the energy ray-curable resin composition and the thermosetting resin further contain the third compound having a chain hydrocarbon group at its terminal end.

The energy ray-curable resin composition and the thermosetting resin each contain a base resin and additives (including an initiator). Preferably, the first, second, and third compounds are additives for the energy ray-curable resin composition and the thermosetting resin composition. In this case, the additive is preferably a leveling agent.

The ultraviolet ray-curable resin composition contains, for example, an initiator and a (meth)acrylate having a (meth)acryloyl group. The (meth)acryloyl group means an acryloyl group or a methacryloyl group. The (meth)acrylate means an acrylate or a methacrylate. The ultraviolet ray-curable resin composition contains, for example, a monofunctional monomer, a bifunctional monomer, a polyfunctional monomer, etc. More specifically, the ultraviolet ray-curable resin composition is one of the materials shown below or a mixture of two or more thereof.

Examples of the monofunctional monomer may include carboxylic acids (such as acrylic acid), hydroxy compounds (such as 2-hydroxyethyl acrylate, 2-hydroxypropyl acrylate, and 4-hydroxybutyl acrylate), alkyl or alicyclic compounds (isobutyl acrylate, t-butyl acrylate, isooctyl acrylate, lauryl acrylate, stearyl acrylate, isobornyl acrylate, and cyclohexyl acrylate), other functional monomers (such as 2-methoxyethyl acrylate, methoxy ethylene glycol acrylate, 2-ethoxyethyl acrylate, tetrahydrofurfuryl acrylate, benzyl acrylate, ethylcarbitol acrylate, phenoxyethyl acrylate, N,N-dimethylaminoethyl acrylate, N,N-dimethylaminopropyl acrylamide, N,N-dimethyl acrylamide, acryloylmorpholine, N-isopropylacrylamide, N,N-diethylacrylamide, N-vinylpyrrolidone, 2-(perfluorooctyl)ethyl acrylate, 3-perfluorohexyl-2-hydroxypropyl acrylate, 3-perfluorooctyl-2-hydroxypropyl acrylate, 2-(perfluorodecyl)ethyl acrylate, 2-(perfluoro-3-methylbutyl)ethyl acrylate, 2,4,6-tribromophenol acrylate, 2,4,6-tribromophenol methacrylate, 2-(2,4,6-tribromophenoxy)ethyl acrylate, and 2-ethylhexyl acrylate.)

Examples of the bifunctional monomer may include tri(propylene glycol)diacrylate, trimethylolpropane diallyl ether, and urethane acrylate.

Examples of the polyfunctional monomer may include trimethylolpropane triacrylate, dipentaerythritol pentaacrylate, dipentaerythritol hexaacrylate, and ditrimethylolpropane tetraacrylate.

Examples of the initiator may include 2,2-dimethoxy-1,2-diphenylethane-1-one, 1-hydroxy-cyclohexyl phenyl ketone, and 2-hydroxy-2-methyl-1-phenylpropane-1-one.

From the viewpoint of, for example, the applicability and stability of the resin component and the smoothness of the coating, the solvent used is mixed into the resin composition. When no solvent is necessary, no solvent may be used. More specifically, the solvent used is, for example, one or a mixture of two or more of: aromatic-based solvents such as toluene and xylene; alcohol-based solvents such as methyl alcohol, ethyl alcohol, n-propyl alcohol, iso-propyl alcohol, n-butyl alcohol, iso-butyl alcohol, and propylene glycol monomethyl ether; ester-based solvents such as methyl acetate, ethyl acetate, butyl acetate, and cellosolve acetate; ketone-based solvents such as acetone, methyl ethyl ketone, methyl isobutyl ketone, and cyclohexanone; glycol ethers such as 2-methoxyethanol, 2-ethoxyethanol, 2-butoxyethanol, ethylene glycol dimethyl ether, ethylene glycol diethyl ether, diethylene glycol dimethyl ether, and propylene glycol methyl ether; glycol ether esters such as 2-methoxyethyl acetate, 2-ethoxyethyl acetate, 2-butoxyethyl acetate, and propylene glycol methyl ether acetate; chlorine-based solvents such as chloroform, dichloromethane, trichloromethane, and methylene chloride; ether-based solvents such as tetrahydrofuran, diethyl ether, 1,4-dioxane, and 1,3-dioxolane; N-methylpyrrolidone; dimethylformamide; dimethyl sulfoxide; and dimethylacetamide. To suppress drying spots and cracks on the coated surface, a high-boiling point solvent may be further added to control the evaporation rate of the solvents. Examples of such a solvent may include butyl cellosolve, diacetone alcohol, butyl triglycol, propylene glycol monomethyl ether, propylene glycol monoethyl ether, ethylene glycol monoethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, and methyl glycol. These solvents may be used singly or in combination of two or more.

### (Application of Resin Composition)

Next, the prepared resin composition is applied to or printed on one of or both the principal surfaces of a substrate. The coating method used may be, for example, wire bar coating, blade coating, spin coating, reverse roll coating, die coating, spray coating, roll coating, gravure coating, micro-gravure coating, lip coating, air knife coating, curtain coating, a comma coating method, or a dipping method. The printing method used may be, for example, a letterpress printing method, an offset printing method, a gravure printing method, an intaglio printing method, a rubber plate printing method, an inkjet method, or a screen printing method.

### (Drying)

Next, if necessary, the resin composition is dried to volatilize the solvent. No particular limitation is imposed on the drying conditions, and any of air drying and artificial drying in which drying temperature and drying time are controlled may be used. However, it is preferable that when wind is blown onto the surface of the coating during drying, the wind be blown such that no wind ripples occur on the coating surface. The drying temperature and the drying time can be appropriately determined from the boiling point of the solvent contained in the coating. In this case, it is preferable to select the drying temperature and the drying time within the range in which no deformation of the substrate 1 due to thermal contraction occurs, in consideration of the heat resistance of the substrate 1.

### (Curing)

Next, the resin composition applied to one principal surface of the substrate 1 is cured by, for example, irradiation with ionizing radiation or heat. An antifouling layer 2 is thereby formed on one of or both the principal surfaces of the substrate 1. The ionizing radiation used may be, for example, ultraviolet rays, visible light, gamma rays, or an electron beam, and ultraviolet rays are preferred from the viewpoint of a production facility. Preferably, the cumulative amount of irradiation is appropriately selected in consideration of the curing properties of the resin composition and suppression of yellowing of the resin composition and the substrate 1. Preferably, the atmosphere during irradiation is appropriately selected according to the type of the resin composition. Examples of the atmosphere may include air and inert gas atmospheres such as nitrogen and argon atmospheres.

The intended antifouling substrate is obtained in the manner described above.

### (Effects)

In the first embodiment, the advancing contact angle of oleic acid on the fingerprint resistant surface S of the antifouling substrate is set to 15° or less, and the receding contact angle of oleic acid is set to 10° or less. Therefore, fingerprints adhering to the fingerprint resistant surface S of the antifouling substrate can be made less noticeable by rubbing the fingerprints with a finger to spread them thinly. The ease of wiping off fingerprints with a finger etc. can thereby be improved.

### [Modifications]

In the first embodiment described above, the example of the configuration in which the antifouling layer 2 contains both the second compound having a cyclic hydrocarbon group and the third compound having a chain hydrocarbon group at a terminal end has been described. However, the present technique is not limited to this example. A configuration in which the antifouling layer 2 contains a fourth compound having a cyclic hydrocarbon group and a chain hydrocarbon group at a terminal end may be employed. Also in this case, the ease of wiping off fingerprints similar to that in the first embodiment described above can be obtained.

In the example of the configuration described in the above first embodiment, the antifouling layer 2 is provided adjacent to one principal surface of the substrate 1, but the configuration of the antifouling substrate is not limited to this example. Modifications of the antifouling substrate will next be described.

### (First Modification)

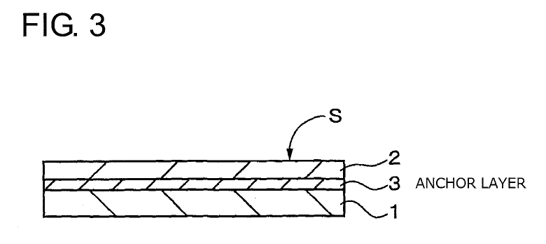

FIG. 3 is a cross-sectional view illustrating an example of a configuration of an antifouling substrate according to a first modification. As shown in FIG. 3, this antifouling substrate is different from the antifouling substrate according to the first embodiment in that an anchor layer 3 disposed between the substrate 1 and the antifouling layer 2 is further provided. When the anchor layer 3 disposed between the substrate 1 and the antifouling layer 2 is provided as described above, the adhesion between the substrate 1 and the antifouling layer 2 can be improved.

The material of the anchor layer 3 used can be selected from, for example, a wide variety of known natural macromolecular resins and synthetic macromolecular resins. For example, transparent thermoplastic resins and transparent curable resins that are cured by heat or irradiation with ionizing radiation can be used as the above resins. Examples of the usable thermoplastic resin may include polyvinyl chloride, vinyl chloride-vinyl acetate copolymers, polymethyl methacrylate, nitrocellulose, chlorinated polyethylene, chlorinated polypropylene, ethyl cellulose, and hydroxypropyl methyl cellulose. Examples of the usable transparent curable resin may include methacrylates, melamine acrylate, urethane acrylate, isocyanates, epoxy resin, and polyimide resin. The ionizing radiation used may be light (for example, ultraviolet rays or visible light), gamma rays, or an electron beam, and ultraviolet rays are preferred from the viewpoint of a production facility.

The material of the anchor layer 3 may further contain an additive. Examples of the additive may include a surfactant, a viscosity modifier, a dispersant, a curing-accelerating catalyst, a plasticizer, and stabilizers such as an antioxidant and an anti-sulfuration agent.

### (Second Modification)

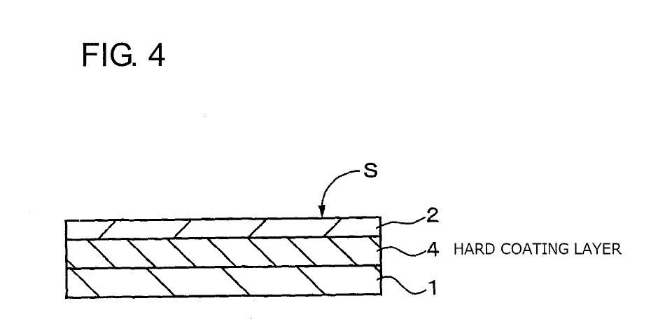

FIG. 4 is a cross-sectional view illustrating an example of a configuration of an antifouling substrate according to a second modification. As shown in FIG. 4, this antifouling substrate is different from the antifouling substrate according to the first embodiment in that a hard coating layer 4 disposed between the substrate 1 and the antifouling layer 2 is further provided. It is particularly preferable to provide the hard coating layer 4 when the substrate 1 used is a resin substrate such as a plastic film. When the hard coating layer 4 is disposed between the substrate 1 and the antifouling layer 2 as described above, practical properties (such as durability and pencil hardness) can be improved.

The material of the hard coating layer 4 used can be selected from, for example, a wide variety of known natural macromolecular resins and synthetic macromolecular resins. For example, transparent thermoplastic resins and transparent curable resins that are cured by heat or irradiation with ionizing radiation can be used as the above resins. Examples of the usable thermoplastic resin may include polyvinyl chloride, vinyl chloride-vinyl acetate copolymers, polymethyl methacrylate, nitrocellulose, chlorinated polyethylene, chlorinated polypropylene, ethyl cellulose, and hydroxypropyl methyl cellulose. Examples of the usable transparent curable resin may include methacrylates, melamine acrylate, urethane acrylate, isocyanates, epoxy resin, and polyimide resin. The ionizing radiation used may be light (for example, ultraviolet rays or visible light), gamma rays, or an electron beam, and ultraviolet rays are preferred from the viewpoint of a production facility.

The material of the hard coating layer 4 may further contain an additive. Examples of the additive may include a surfactant, a viscosity modifier, a dispersant, a curing-accelerating catalyst, a plasticizer, and stabilizers such as an antioxidant and an anti-sulfuration agent. The hard coating layer 4 may further contain light-scattering particles such as an organic resin filler that scatter light, in order to impart an AG (Anti-Glare) function to the fingerprint resistant surface S. In this case, the light-scattering particles may protrude from the surface of the hard coating layer 4 or the fingerprint resistant surface S of the antifouling layer 2 or may be covered with a resin contained in the hard coating layer 4 or the antifouling layer 2. The light-scattering particles may or may not be in contact with the substrate 1, which is a lower layer. Both the hard coating layer 4 and the antifouling layer 2 may further contain light-scattering particles. Instead of or in addition to the AG (Anti-Glare) function, an AR (Anti-Reflection) function may be imparted to the antifouling substrate. The AR (Anti-Reflection) function can be imparted by, for example, forming an AR layer on the hard coating layer 4. The AR layer used may be, for example, a single low-refractive index layer film or a multilayer film formed by alternately stacking low-refractive index layers and high-refractive index layers.

### (Third Modification)

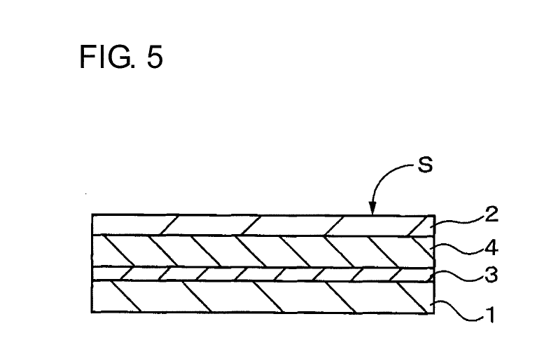

FIG. 5 is a cross-sectional view illustrating an example of a configuration of an antifouling substrate according to a third modification. As shown in FIG. 5, this antifouling substrate is different from the antifouling substrate according to the first embodiment in that a hard coating layer 4 disposed between the substrate 1 and the antifouling layer 2 and an anchor layer 3 disposed between the substrate 1 and the hard coating layer 4 are further provided. It is particularly preferable to provide the hard coating layer 4 when the substrate 1 used is a resin substrate such as a plastic film.

### (Fourth Modification)

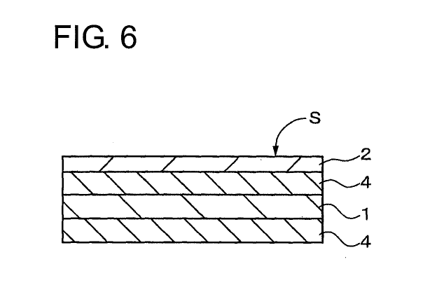

FIG. 6 is a cross-sectional view illustrating an example of a configuration of an antifouling substrate according to a fourth modification. As shown in FIG. 6, this antifouling substrate is different from the antifouling substrate according to the first embodiment in that hard coating layers 4 are further provided on both the principal surfaces of the substrate 1. The antifouling layer 2 is disposed on the surface of one of the hard coating layers 4 disposed on both the principal surfaces of the substrate 1. It is particularly preferable to provide the hard coating layers 4 when the substrate 1 used is a resin substrate such as a plastic film.

### (Fifth Modification)

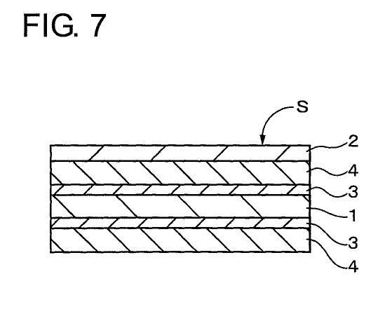

FIG. 7 is a cross-sectional view illustrating an example of a configuration of an antifouling substrate according to a fifth modification. As shown in FIG. 7, this antifouling substrate is different from the antifouling substrate according to the first embodiment in that anchor layers 3 and hard coating layers 4 are further provided on both the principal surfaces of the substrate 1. Each anchor layer 3 is disposed between the substrate 1 and a hard coating layer 4. The antifouling layer 2 is disposed on the surface of one of the hard coating layers 4 disposed on both the principal surfaces of the substrate 1. It is particularly preferable to provide the hard coating layers 4 when the substrate 1 used is a resin substrate such as a plastic film.

### 2. Second Embodiment

### Configuration of Antifouling Substrate

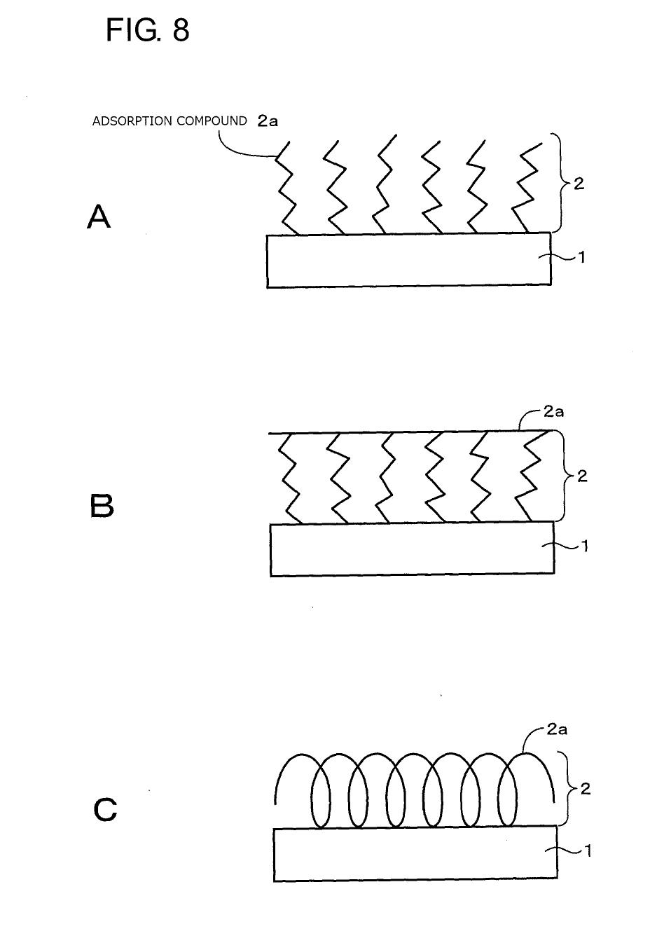

FIGS. 8A to 8C are schematic diagrams illustrating examples of configurations of an antifouling substrate according to a second embodiment of the present technique. The antifouling substrate according to the second embodiment is different from the antifouling substrate according to the first embodiment in that an adsorption compound 2a is adsorbed on one of the principal surfaces of the substrate 1 to thereby form an antifouling layer 2. The substrate 1 may include a layer (such as an anchor layer or a hard coating layer) other than the antifouling layer. The antifouling layer 2 is, for example, a monomolecular layer formed from the adsorption compound 2a. The region on which the adsorption compound 2a is adsorbed is not limited to one of the principal surfaces of the substrate 1, and the adsorption compound 2a may be adsorbed on both the principal surfaces of the substrate 1 or part of the principal surfaces. The adsorption compound 2a may be adsorbed selectively on a principal surface or a region that are frequently touched with a hand, a finger, etc.

The site of the adsorption compound 2a that is adsorbed on the surface of the substrate 1 may be any of the terminal ends of the side and main chains of the adsorption compound 2a, and both a terminal end of a side chain and a terminal end of the main chain may be adsorbed on the surface of the substrate 1. FIG. 8A shows a configuration in which one terminal end of the main chain of the adsorption compound 2a is adsorbed on the surface of the substrate 1. FIG. 8B shows a configuration in which terminal ends of side chains of the adsorption compound 2a are adsorbed on the surface of the substrate 1. FIG. 8C shows a configuration in which the main chain of the adsorption compound 2a is adsorbed on the surface of the substrate 1. The adsorption may be any of physical adsorption and chemical adsorption. From the viewpoint of durability, chemical adsorption is preferred. Specific examples of the adsorption include adsorption through an acid-base reaction, a covalent bond, an ionic bond, a hydrogen bond, etc.

The adsorption compound 2a used may be prepared by adding an adsorption group that adsorbs on the surface of the substrate 1 to, for example, the first and second compounds in the first embodiment described above. The position at which the adsorption group is attached may be any of the terminal ends and side chains of the adsorption compound 2a, and a plurality of adsorption groups may be added to one molecule of the adsorption compound 2a.

Any adsorption group may be used so long as it can be adsorbed to the substrate 1. Specific examples of the adsorption group may include a sulfo group (including sulfonates), a sulfonyl group, a carboxylic acid group (including carboxylates), an amino group, a phosphoric acid group (including phosphates and phosphoric esters), a phosphino group, an epoxy group, an isocyanate group, and a thiol group. It is sufficient that at least one such adsorption group be present in the adsorption compound 2a.

A compound having, in its molecule, a structure represented by the formula (7) below can be used as the first compound having an adsorption group.

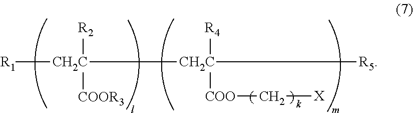

In the formula (7), X is, for example, a sulfo group (including a sulfonate group), a sulfonyl group, a carboxylic acid group (including a carboxylate group), an amino group, a phosphoric acid group (including a phosphate group and a phosphoric ester group), a phosphino group, an epoxy group, an isocyanate group, a thiol group, etc.

A compound having, in its molecule, a structure represented by the formula (8) below can be used as the second compound having an adsorption group.

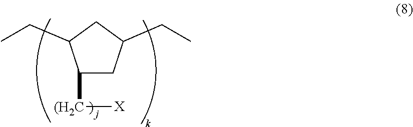

In the formula (8), X is, for example, a sulfo group (including a sulfonate group), a sulfonyl group, a carboxylic acid group (including a carboxylate group), an amino group, a phosphoric acid group (including a phosphate group and a phosphoric ester group), a phosphino group, an epoxy group, an isocyanate group, a thiol group, etc.

A compound having, in its molecule, a structure represented by the formula (9) below can be used as the third compound having an adsorption group.

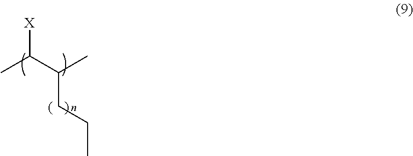

In the formula (9), X is, for example, a sulfo group (including a sulfonate group), a sulfonyl group, a carboxylic acid group (including a carboxylate group), an amino group, a phosphoric acid group (including a phosphate group and a phosphoric ester group), a phosphino group, an epoxy group, an isocyanate group, a thiol group, etc.

### [Method of Producing Antifouling Substrate]

A description will next be given of an example of a method of producing the antifouling substrate using a wet process.

### (Preparation of Adsorption Compound Solution)

First, the adsorption compound 2a is dissolved in a solvent to prepare a processing solution. When the adsorption compound 2a is liquid at room temperature or is subjected to, for example, heat treatment to obtain the adsorption compound 2a in a liquid state, the liquid adsorption compound 2a may be used without any solvent. When the processing solution comes close to the surface of the substrate 1, the adsorption compound 2a is adsorbed on the surface. The adsorption rate increases as the amount of the adsorption compound in the processing solution increases. Therefore, the higher the concentration of the compound is, the more it is preferred. Specifically, the concentration of the compound is preferably 0.01% by mass or more.

The solvent used may be appropriately selected from those that can dissolve the adsorption compound 2a at a prescribed concentration. More specifically, the solvent used is, for example, one or a mixture of two or more of: aromatic-based solvents such as toluene and xylene; alcohol-based solvents such as methyl alcohol, ethyl alcohol, n-propyl alcohol, iso-propyl alcohol, n-butyl alcohol, iso-butyl alcohol, and propylene glycol monomethyl ether; ester-based solvents such as methyl acetate, ethyl acetate, butyl acetate, and cellosolve acetate; ketone-based solvents such as acetone, methyl ethyl ketone, methyl isobutyl ketone, and cyclohexanone; glycol ethers such as 2-methoxyethanol, 2-ethoxyethanol, 2-butoxyethanol, ethylene glycol dimethyl ether, ethylene glycol diethyl ether, diethylene glycol dimethyl ether, and propylene glycol methyl ether; glycol ether esters such as 2-methoxyethyl acetate, 2-ethoxyethyl acetate, 2-butoxyethyl acetate, and propylene glycol methyl ether acetate; chlorine-based solvents such as chloroform, dichloromethane, trichloromethane, and methylene chloride; ether-based solvents such as tetrahydrofuran, diethyl ether, 1,4-dioxane, and 1,3-dioxolane; N-methylpyrrolidone; dimethylformamide; dimethyl sulfoxide; and dimethylacetamide.

### (Adsorption)

Next, for example, the substrate 1, which is a processing target, is immersed in the processing solution, or a prescribed amount of the processing solution is applied to or printed on one of or both the principal surfaces of the substrate 1 used as the processing target.

The coating method used may be, for example, wire bar coating, blade coating, spin coating, reverse roll coating, die coating, spray coating, roll coating, gravure coating, micro-gravure coating, lip coating, air knife coating, curtain coating, a comma coating method, or a dipping method. The printing method used may be, for example, a letterpress printing method, an offset printing method, a gravure printing method, an intaglio printing method, a rubber plate printing method, an inkjet method, or a screen printing method.

When an immersion method is used, the processing solution in an amount sufficient to allow the substrate 1 used as the processing target to be immersed therein is prepared, and it is preferable that the substrate 1 be immersed in the processing solution for 0.1 seconds to 48 hours. If necessary, after immersion, the substrate 1 may be washed with a good solvent for the adsorption compound 2a to rinse out the unadsorbed adsorption compound 2a. Then the resultant substrate 1 is dried as needed, and the adsorption processing is thereby completed. The drying method may be, for example, any of natural drying and artificial drying using a heating apparatus. When heat treatment and/or ultrasonic treatment is performed during immersion of the substrate 1 used as the processing target, the rate of adsorption of the adsorption compound 2a can be increased.

When a coating method is used, heat treatment and/or ultrasonic treatment may also be performed on the substrate 1 when the processing solution is applied to the substrate 1. If necessary, after application, the substrate 1 may be washed with a good solvent for the adsorption compound 2a to rinse out the unadsorbed adsorption compound 2a. Then the resultant substrate 1 is dried as needed, and the adsorption processing is thereby completed. The drying method may be, for example, any of natural drying and artificial drying using a heating apparatus. It is not necessary to achieve the desired amount of application of the processing solution only by one application step, and the desired amount of application of the processing solution may be achieved by repeating the above application and washing steps a plurality of times.

### (Effects)

In the second embodiment, the adsorption compound 2a is adsorbed on the surface of the substrate 1 to form the antifouling layer 2 on the surface of the substrate 1. Therefore, the same effects as those in the first embodiment described above can be obtained.

### [Modification]

In the first and second embodiments described above, the method using a wet process has been described as an example of the method of producing the antifouling substrate. The method of producing the antifouling substrate is not limited to this example, and a dry process can also be used. More specifically, a dry process can be used to form the antifouling layer 2 in the first embodiment or the second embodiment described above directly on the surface of the substrate 1.

The dry process used may be, for example, a sputtering method, a thermal CVD (Chemical Vapor Deposition) method, a plasma CVD method, an ALD (Atomic Layer Deposition) method, an ion plating method, etc. The thickness of the antifouling layer 2 is within the range of, for example, a monomolecular thickness or more and 1 mm or less, preferably a monomolecular thickness or more and 100 μm or less, and particularly preferably a monomolecular thickness or more and 10 μm or less.

### 3. Third Embodiment

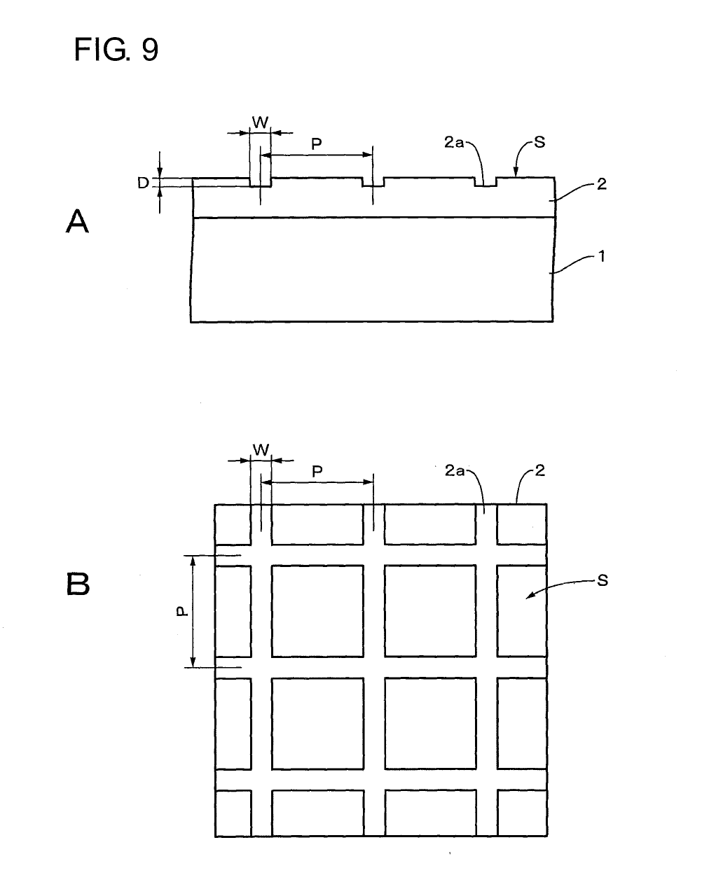

FIG. 9A is a cross-sectional view illustrating an example of a configuration of an antifouling substrate according to a third embodiment of the present technique. FIG. 9B is a plan view illustrating the example of the configuration of the antifouling substrate according to the third embodiment of the present technique. The antifouling substrate according to the third embodiment is different from that in the first embodiment in that recesses 2a are formed on the fingerprint resistant surface S of the antifouling layer 2.

On the fingerprint resistant surface S having the recesses 2a formed thereon, the advancing contact angle of oleic acid is 9.8° or less, and the receding contact angle of oleic acid is 4° or less. In this case, when fingerprints adhering to the fingerprint resistant surface S are rubbed with a finger, the fingerprints can be spread more thinly than those when the fingerprint resistant surface S is flat, so that the fingerprints can be made much less noticeable. Therefore, when the antifouling substrate or the antifouling layer 2 is applied to an input device or a display device, fingerprints can become less noticeable with use of the device over time.

The recesses 2a are provided to generate positive capillary pressure on the surface of a liquid present on the fingerprint resistant surface S and to increase the surface area of the fingerprint resistant surface S. When these recesses 2a are provided on the fingerprint resistant surface S, the advancing contact angle and receding contact angle of oleic acid on the surface can be made lower than those when the fingerprint resistant surface S is flat. More specifically, the ease of wiping off fingerprints with a finger etc. can be further improved.

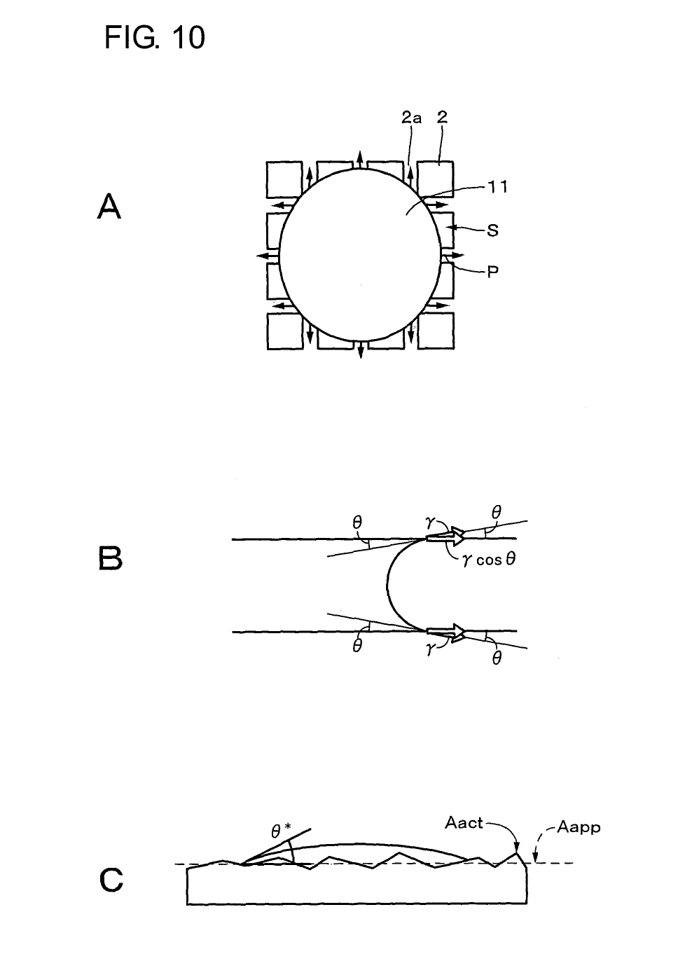

FIG. 10A is a schematic diagram for explaining directions of capillary pressure on the fingerprint resistant surface. The capillary pressure P acts in plane directions on the fingerprint resistant surface S that extend away from a liquid droplet 11. Capillary pressure P acting in a direction away from the liquid droplet 11 on the fingerprint resistant surface S is defined as positive capillary pressure P. When positive capillary pressure P acts on the liquid droplet 11 present on the fingerprint resistant surface S, the liquid droplet 11 is allowed to spread thinly. It is preferable to allow capillary pressure p in a depth direction to act in addition to the positive capillary pressure P. This is because the capillary pressure p allows the liquid droplet 11 to spread more thinly.

The plurality of recesses 2a are provided on the fingerprint resistant surface S of the antifouling layer 2 in a regular or random pattern. The recesses 2a used may be, for example, holes or grooves. From the viewpoint of allowing fingerprints etc. to spread, grooves are preferably used.

The grooves used may be, for example, one-dimensional grooves extending in one direction or two-dimensional grooves extending in two directions. From the viewpoint of allowing fingerprints etc. to spread two-dimensionally, two-dimensional grooves are preferably used.

Examples of the shape of the grooves as viewed from a direction perpendicular to the fingerprint resistant surface S may include, but are not limited to, a stripe shape, a grid shape, a mesh shape, a concentric circle shape, and a spiral shape. The grooves may be wobbled in plane directions. The depth and/or width of the grooves may be changed randomly or periodically in their extending direction. FIG. 9B shows an example in which grooves serving as the recesses 2a have a grid shape.

No particular limitation is imposed on the cross-sectional shape of the grooves cut in a direction perpendicular to their extending direction, so long as capillary pressure can be generated and the surface area can be increased. Examples of the cross-sectional shape may include a U-shape, a V-shape, a semicircular shape, and a semielliptical shape.

The shape of the holes used may be, for example, a columnar shape, conical shapes, a hemispherical shape, a semielliptical shape, and irregular shapes but is not limited to these shapes. The holes may be arranged in any of regular and random patterns, and a combination of regular and random patterns may be used.

The recesses 2a may be recesses disposed between projections. The shape of the projections may be, for example, a columnar shape, conical shapes, a hemispherical shape, a semielliptical shape, and irregular shapes but is not limited to these shapes. The projections may be arranged in any of regular and random patterns, and a combination of regular and random patterns may be used.

The width W and depth D of the recesses 2a are set to a width and a depth that allow capillary pressure to be generated and the surface area to be increased. More specifically, the width W of the recesses 2a is within the range of preferably 1 nm or more and 1 mm or less. The depth D of the recesses 2a is within the range of preferably 1 nm or more and 1 mm or less.

The pitch P of the recesses 2a is set to a pitch that allows capillary pressure to be generated and the surface area to be increased. More specifically, the pitch P of the recesses 2a is within the range of preferably 1 nm or more and 1 mm or less.

When the following two effects (the effect of capillary pressure and the effect of the increased surface area) can be obtained by providing a plurality of recesses 2a on the fingerprint resistant surface S of the antifouling layer 2 to form an uneven surface, it is considered that the contact angles on the uneven surface may be smaller than those on a flat surface.

### (Capillary Pressure)

FIG. 10B is a schematic diagram for explaining capillarity on an uneven surface. The capillarity on the uneven surface is represented by the Lucas-Washburn equation (1) below.

L=√(ry cos θt/2η) (1)

L=displacement (travelling distance), r: capillary radius, γ cos θ: penetration, γ: surface tension of liquid, θ: contact angle, η: viscosity, t: time

### (Increased Surface Area)

FIG. 10C is a schematic diagram for explaining a contact angle on an uneven surface. The contact angle on the uneven surface is represented by the Wenzel equation (2) below.

cos θ*=r cos θ (2)

r (actual surface coefficient): A_{act}/Aₐₚₚ (A_{act}: actual area, Aₐₚₚ: apparent area), θ*: contact angle on the uneven surface, θ: contact angle on a flat surface

In the third embodiment, since a plurality of recesses 2a are provided on the fingerprint resistant surface (antifouling surface) S, the advancing contact angle of oleic acid and the receding contact angle of oleic acid on the fingerprint resistant surface S can be reduced as compared with those in the first embodiment. Therefore, the ease of wiping off fingerprints with a finger etc. can be further improved.

### [Modification]

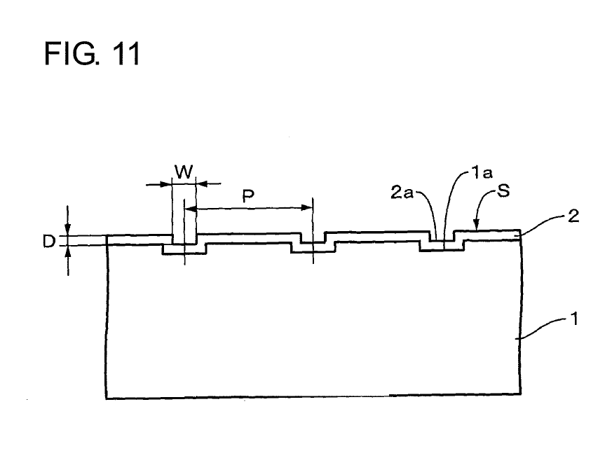

FIG. 11 is a cross-sectional view illustrating an example of a configuration of an antifouling substrate according to a modification. Recesses 1a may be provided on the surface of the substrate 1, and then recesses 2a of the antifouling layer 2 may be provided so as to conform to the recesses 1a. In the antifouling substrate configured as described above, the antifouling layer 2 used may be the antifouling layer 2 in the second embodiment. More specifically, the adsorption compound 2a may be adsorbed on the surface of the substrate 1 having a plurality of recesses 1a formed thereon to thereby form an antifouling layer 2.

### 4. Fourth Embodiment

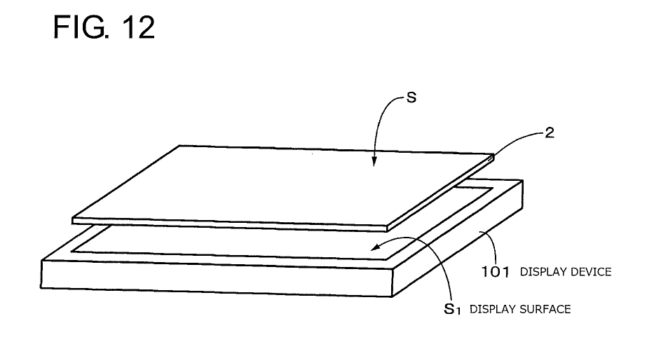

FIG. 12 is a perspective view illustrating an example of a configuration of a display device according to a fourth embodiment of the present technique. As shown in FIG. 12, an antifouling layer 2 is provided on a display surface S₁ of the display device 101. In the example shown in FIG. 12, the antifouling layer 2 is disposed directly on the display surface S₁ of the display device 101. However, an antifouling substrate may be applied to the display surface S₁ of the display device 101 to thereby provide an antifouling layer 2 on the display surface S₁ of the display device 101. When the antifouling substrate is applied to the display surface S₁ as described above, a configuration in which the antifouling substrate is bonded to the display surface S₁ of the display device 101 through a bonding layer can be used. When this configuration is used, it is preferable to use, for example, a transparent and flexible sheet as the substrate 1 of the antifouling substrate.

The display device 101 used may be any of various display devices such as a liquid crystal display, a CRT (Cathode Ray Tube) display, a plasma display (Plasma Display Panel: PDP), an electroluminescent (Electro Luminescence: EL) display, and a surface-conduction electron-emitter display (Surface-conduction Electron-emitter Display: SED).

In the fourth embodiment, since the display surface S₁ of the display device 101 can serve as the fingerprint resistant surface S, fingerprints etc. adhering to the display surface S₁ of the display device can be made less noticeable by rubbing the fingerprints with, for example, a finger to spread them thinly. Therefore, the visibility of the display device 101 can be improved.

### 5. Fifth Embodiment

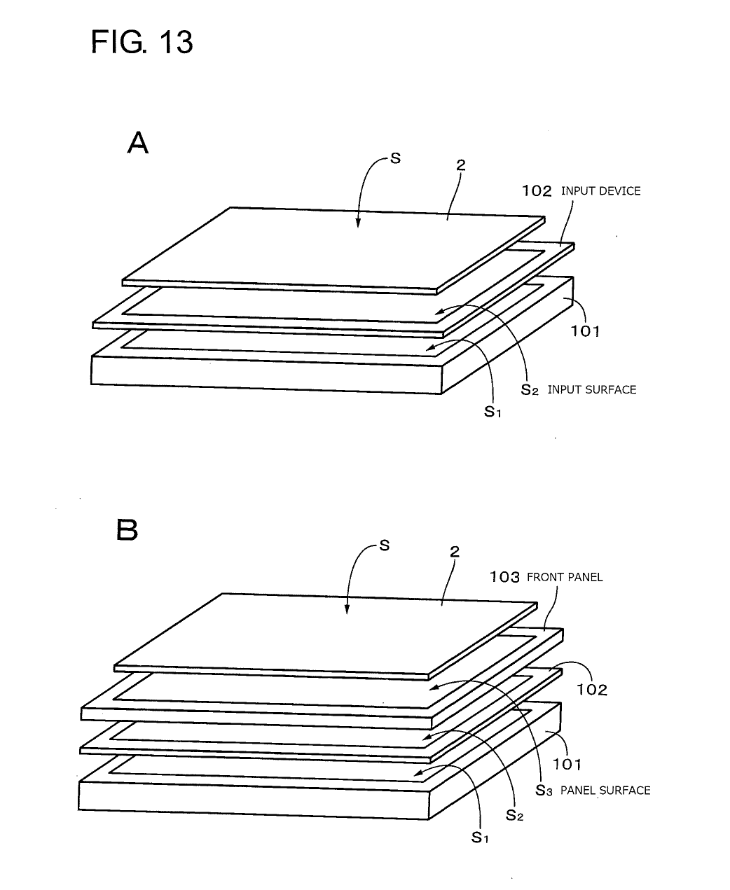

FIG. 13A is a perspective view illustrating an example of a configuration of a display device according to a fifth embodiment of the present technique. As shown in FIG. 13A, an input device 102 is disposed on the display surface S₁ of the display device 101. An antifouling layer 2 is disposed on an input surface S₂ of the input device 102. The display device 101 and the input device 102 are bonded to each other through a bonding layer formed of, for example, an adhesive. In the example shown in FIG. 13A, the antifouling layer 2 is disposed directly on the input surface S₂ of the input device 102. However, an antifouling substrate may be applied to the input surface S₂ of the input device 102 to thereby provide an antifouling layer 2 on the input surface S₂ of the input device 102. When the antifouling substrate is applied to the input surface S₂ as described above, a configuration in which the antifouling substrate is bonded to the input surface S₂ of the input device 102 through a bonding layer can be used. When this configuration is used, it is preferable to use, for example, a transparent and flexible sheet as the substrate 1 of the antifouling substrate.

The input device 102 is, for example, a resistive film or capacitive touch panel. Examples of the resistive film touch panel may include a matrix resistive film touch panel. Examples of the capacitive touch panel may include a projection capacitive touch panel of the Wire Sensor type and a projection capacitive touch panel of the ITO Grid type.

In the fifth embodiment, the input surface S₂ of the input device 102 can serve as the fingerprint resistant surface S, so that fingerprints adhering to the input surface S₂ of the input device 102 can be made less noticeable by rubbing the fingerprints with a finger etc. to spread them thinly. Therefore, the visibility of the display device 101 equipped with the input device 102 can be improved.

### [Modification]

FIG. 13B is an exploded perspective view illustrating an example of a configuration of a modification of the input device according to the fifth embodiment of the present technique. As shown in FIG. 13B, a front panel (surface member) 103 may be provided on the input surface S₂ of the input device 102. In this case, an antifouling layer 2 is provided on a panel surface S₃ of the front panel 103. The input device 102 and the front panel (surface member) 103 are bonded to each other through a bonding layer formed of, for example, an adhesive.

### EXAMPLES

Examples of the present technique will be described in the following order.

1. Surface containing compound having ester linkage

2. Surface containing compound having cyclic hydrocarbon group

3. Dynamic contact angles

4. Surface having groove shape

The present technique will next be specifically described by way of Examples. However, the present technique is not limited only to these Examples.

### 1. Surface Containing Compound Having Ester Linkage

### Example 1

A resin composition having a chemical composition shown below was applied to an 80 μm-thick TAC film (manufactured by Fujifilm Corporation) using a No. 3 coil bar and dried at 80° C. for 2 minutes to form an antifouling layer on the TAC film. The target antifouling film was thereby obtained.

### (Chemical Composition of Resin Composition)

Compound having a structure represented by the formula (10) below: 10% by mass

Solvent (methyl isobutyl ketone): 90% by mass

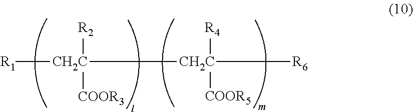

Molecular weight (Mw): 100,000 R₁, R₂, and R₆ are each a hydrocarbon group, R₃ is a hydrocarbon group having 2 or more carbon atoms, and R₅ is a group having 2 or more carbon atoms and having an amino group at an intermediate position and/or a terminal end.

### Example 2

A resin composition having a chemical composition shown below was applied to an 80 μm-thick TAC film (manufactured by Fujifilm Corporation) using a No. 3 coil bar and dried at 80° C. for 2 minutes to form an antifouling layer on the TAC film. The target antifouling film was thereby obtained.

### (Chemical Composition of Resin Composition)

Compound having a structure represented by the formula (11) below: 10% by mass

Solvent (methyl ethyl ketone): 90% by mass

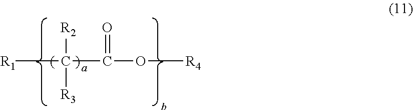

Molecular weight (Mn): 8,000

R₁ to R₄ are each a hydrocarbon group.

### Example 3

A resin composition having a chemical composition shown below was applied to an 80 μm-thick TAC film (manufactured by Fujifilm Corporation) using a No. 5 coil bar, dried at 80° C. for 2 minutes, and then subjected to UV curing in a nitrogen atmosphere to form an antifouling layer on the TAC film.

### (Chemical Composition of Resin Composition)

Hydrophilic hard coating (product name: PHOLUCID 440C-M with no initiator, manufactured by CHUGOKU MARINE PAINTS, LTD.): 38.4% by mass

Polyfunctional acrylate (product name: A-TMM-3L, manufactured by Shin-Nakamura Chemical Co., Ltd.): 10.5% by mass

Photopolymerization initiator (product name: IRGACURE-127, manufactured by BASF Japan Ltd.): 1.1% by mass

Solvent (ethanol): 50% by mass

The resultant TAC film was immersed in a processing solution having a chemical composition shown below at room temperature for 10 seconds to allow the compound to be adsorbed on the surface of the hydrophilic hard coating. Then the product was sufficiently rinsed with acetonitrile and dried at 80° C. for 2 minutes. The target antifouling film was thereby obtained.

### (Chemical Composition of Processing Solution)

Compound having a structure represented by the formula (12) below: 10% by mass

Solvent (acetonitrile): 90% by mass

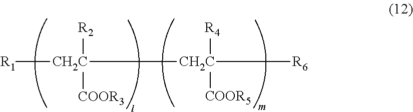

Molecular weight (Mw): 100,000

R₁, R₂, and R₆ are each a hydrocarbon group, R₃ is a hydrocarbon group having 2 or more carbon atoms, and R₅ is a group having 2 or more carbon atoms and having an amino group at an intermediate position and/or a terminal end.

### Example 4

A resin composition having a chemical composition shown below was applied to an 80 μm-thick TAC film (manufactured by Fujifilm Corporation) using a No. 10 coil bar, dried at 80° C. for 2 minutes, and then subjected to UV curing in a nitrogen atmosphere to form an antifouling layer on the TAC film. The target antifouling film was thereby obtained.

### (Chemical Composition of Resin Composition)

Urethane acrylate (product name: CN9006, manufactured by SARTOMER JAPAN INC.): 9.4% by mass

Photopolymerization initiator (product name: IRGACURE-184, manufactured by BASF Japan Ltd.): 0.5% by mass

Solvent (t-butanol): 90% by mass

Leveling agent (a compound having a structure represented by the formula (13) below): 0.1% by mass

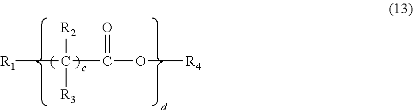

R₁ to R₄ are each a hydrocarbon group.

### Comparative Example 1

A compound having a structure represented by the formula (14) below and containing fluorine atoms was adhered to a glass substrate using an evaporation method. The target surface-treated substrate was thereby obtained.

R₁ is a hydrocarbon group containing fluorine atoms, and R₂ is a hydrocarbon group having five or less carbon atoms.

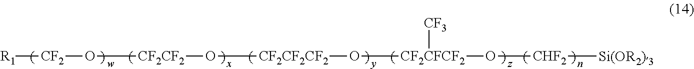

### Comparative Example 2

A resin composition having a chemical composition shown below was applied to an 80 μm-thick TAC film (manufactured by Fujifilm Corporation) using a No. 5 coil bar, dried at 80° C. for 2 minutes, and then subjected to UV curing in a nitrogen atmosphere to form an antifouling layer on the TAC film. The target antifouling film was thereby obtained.

### (Chemical Composition of Resin Composition)

Urethane acrylate (product name: CN9006, manufactured by SARTOMER JAPAN INC.): 9.4% by mass

Photopolymerization initiator (product name: IRGACURE-184, manufactured by BASF Japan Ltd.): 0.5% by mass

Solvent (t-butanol): 90% by mass

Oleophilizing agent (cetyl acrylate): 0.1% by mass

Next, “evaluation of dynamic contact angles,” “evaluation of ease of wiping off fingerprints,” and “evaluation of hardness” were performed on the surface of each of the above-obtained antifouling films in Examples 1 to 4 and Comparative Examples 1 and 2. The results are shown in TABLE 1.

### (Evaluation of Static Contact Angles of Water and Oleic Acid)

A portable contact angle meter (product name: PCA-1, manufactured by Kyowa Interface Science Co., Ltd.) was used to evaluate the static contact angles of water and oleic acid under the following conditions. The results are shown in TABLE 1.
Water was placed in a plastic syringe, and a stainless steel-made needle (15G) was attached to the end of the plastic syringe. Then water was dropped onto an evaluation surface.
Oleic acid was placed in a plastic syringe, and a Teflon-made needle (18G) was attached to the end of the plastic syringe. Then oleic acid was dropped onto an evaluation surface.
Volume of dropped liquid droplet: 2 μl (water), 1 μl (oleic acid)
Measurement temperature: 25° C.

### (Evaluation of Dynamic Contact Angles)

An automatic contact angle meter (product name: DM-501, manufactured by Kyowa Interface Science Co., Ltd.) was used to evaluate the advancing contact angle and receding contact angle of oleic acid at the time of the start of sliding using a sliding method under the following conditions. The results are shown in TABLE 1.

The definitions of the advancing contact angle and receding contact angle are as described with reference to FIG. 2.
Oleic acid was placed in a plastic syringe, and a stainless steel-made needle was attached to the end of the plastic syringe. Then oleic acid was dropped onto an evaluation surface.
Volume of dropped oleic acid: 5 μl
Measurement temperature: 25° C.
The determination that the droplet started falling was made when the lower side of the inclined droplet started moving.
The advancing contact angle and the receding contact angle were determined by a tangent method.

### (Evaluation of Ease of Wiping Off Fingerprints)

First, a prepared sample was bonded to a black acrylic plate (product name: ACRYLITE, manufactured by MITSUBISHI RAYON Co., Ltd.) with an evaluation surface of the sample facing up using a double-sided adhesive sheet (product name: LUCIACS CS9621T, manufactured by NITTO DENKO Corporation). Next, the evaluation surface was smudged with fingerprints, and the smudged portion was rubbed with a finger 5 times. A fluorescent lamp was used to irradiate the evaluation surface. Then the evaluation surface was visually observed, and evaluation was made according to the following criteria. The results are shown in TABLE 1.

4: The fingerprint smudges were less noticeable than those with evaluation rating “3.”

3: The fingerprint smudges were almost unnoticeable.

2: The fingerprint smudges were slightly noticeable.

1: The fingerprint smudges were clearly noticeable.

### (Evaluation of Hardness)

Hardness evaluation was performed using Martens hardness. The Martens hardness was evaluated using PICODENTOR HM500 (product name, manufactured by Fischer Instruments K.K.). A load of 3 mN was used. A diamond cone was used as a needle, and the measurement was performed at a face angle of 136°.

### (Evaluation of Critical Surface Tension)

A portable contact angle meter (product name: PCA-1, manufactured by Kyowa Interface Science Co., Ltd.) was used to evaluate the static contact angles of water, ethylene glycol, and hexadecane under the following conditions. Then the critical surface tension was computed using a Zisman Plot. The results are shown in TABLE 1.
Water and ethylene glycol were placed in plastic syringes, and stainless steel-made needles (15G) were attached to the ends of the plastic syringes. Then water and ethylene glycol were dropped onto an evaluation surface.
Hexadecane was placed in a plastic syringe, and a Teflon-made needle (22G) was attached to the end of the plastic syringe. Then hexadecane was dropped onto an evaluation surface.
Volume of dropped liquid droplet: 2 μl
Measurement temperature: 25° C.

TABLE 1 shows the evaluation results in Examples 1 to 4 and Comparative Examples 1 and 2.

TABLE 1

| | Static | | | | | | | |
|---|---|---|---|---|---|---|---|---|
| | Contact | | | Ease of | | | Critical | |
| | Angle of | Advancing | Receding | Wiping Off | Martens | Contact | Surface | |
| | Oleic Acid | Contact | Contact Angle | Fingerprints | Hardness | Angle of | Tension | Surface |
| | (°) | Angle (°) | (°) | with Finger | (N/mm²) | Water (°) | (mN/m) | Structure |
| Example 1 | 10.8 | 14.7 | 8.1 | 3 | — | 62.6 | 26.1 | Acrylic Polymer |
| | | | | | | | | (with Ester |
| | | | | | | | | Linkage) |
| Example 2 | 10.6 | 14.4 | 8.5 | 3 | — | 76.8 | 26.3 | Polyester (with |
| | | | | | | | | Ester Linkage in |
| | | | | | | | | Main Chain) |
| Example 3 | 11.0 | 14.5 | 9.2 | 3 | — | 59.2 | 26.1 | Acrylic Polymer |
| | | | | | | | | (with Ester |
| | | | | | | | | Linkage) |
| Example 4 | 11.6 | 15.0 | 9.1 | 2 | 295 | 75.6 | 27.4 | Acrylic Polymer |
| | | | | | | | | (with Ester |
| | | | | | | | | Linkage) |
| Comparative | 73.4 | 76.9 | 71.5 | 1 | — | 103.9 | — | Fluorine-Based |
| Example 1 | | | | | | | | compound |
| Comparative | 18.6 | 26.3 | 16.3 | 1 | — | 73.2 | 26.9 | Linear Chain Alkyl + |
| Example 2 | | | | | | | | Ester Linkage |

### (Discussion)

The following can be seen from TABLE 1.

### Examples 1 and 2

Since the antifouling layer was formed from a compound having an ester linkage, the dynamic contact angles of oleic acid were small, and favorable wipeability was obtained.

### Example 3

Even when a compound having an ester linkage was adsorbed on the surface, favorable wipeability was obtained.

### Example 4

Even when the antifouling layer was formed using a material composed mainly of an acrylic compound, the dynamic contact angles on the surface can be suppressed by adding, as a leveling agent, a compound having an ester linkage to the material, and the wipeability can thereby be improved.

### Comparative Example 1

The dynamic contact angles were high on the water-repellent and oil-repellent surface, and therefore wipeability with a finger was low.

### Comparative Example 2

Fingerprints adhering to the oleophilic film were less noticeable. However, the dynamic contact angels were high, and therefore wipeability with a finger was low.

### 2. Surface Containing Compound Having Cyclic Hydrocarbon Group

### Example 5

A resin composition having a chemical composition shown below was applied to a 100 μm-thick ZEONOR film (manufactured by ZEON CORPORATION) using a No. 3 coil bar, dried at 80° C. for 2 minutes, and then subjected to UV curing in a nitrogen atmosphere to form an antifouling layer. The target antifouling film was thereby obtained.

### (Chemical Composition of Resin Composition)

Bifunctional acrylate having a structure represented by the formula (15) below: 9.5% by mass

IRGACURE-184 (photopolymerization initiator manufactured by BASF Japan Ltd.): 0.5% by mass

Solvent (methyl isobutyl ketone): 90% by mass

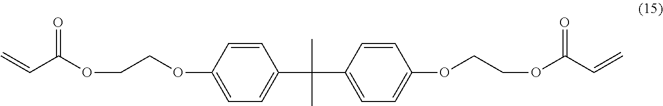 [SMILES: C=CC(=O)OCCOc1ccc(C(C)(C)c2ccc(OCCOC(=O)C=C)cc2)cc1]

### Example 6

A resin composition having a chemical composition shown below was applied to a 100 μm-thick ZEONOR film (manufactured by ZEON CORPORATION) using a No. 3 coil bar, dried at 80° C. for 2 minutes, and then subjected to UV curing in a nitrogen atmosphere to form an antifouling layer. The target antifouling film was thereby obtained.

### (Chemical Composition of Resin Composition)

Bifunctional acrylate having a structure represented by the formula (16) below: 9.5% by mass

IRGACURE-184 (photopolymerization initiator manufactured by BASF Japan Ltd.): 0.5% by mass

Solvent (methyl isobutyl ketone): 90% by mass

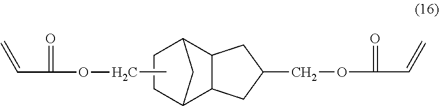

### Example 7

A resin composition having a chemical composition shown below was applied to a 100 μm-thick ZEONOR film (manufactured by ZEON CORPORATION) using a No. 3 coil bar, dried at 80° C. for 2 minutes, and then subjected to UV curing in a nitrogen atmosphere to form an antifouling layer. The target antifouling film was thereby obtained.

### (Chemical Composition of Resin Composition)

Bifunctional acrylate having a structure represented by the formula (17) below: 9.4905% by mass

Monofunctional methacrylate having a structure represented by the formula (18) below: 0.0095% by mass

IRGACURE-184 (photopolymerization initiator manufactured by BASF Japan Ltd.): 0.5% by mass

Solvent (methyl isobutyl ketone): 90% by mass

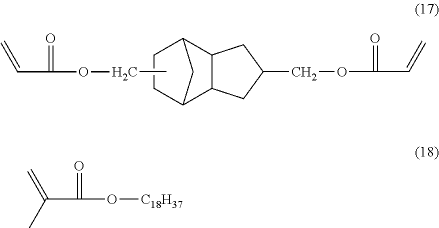

### Example 8

A resin composition having a chemical composition shown below was applied to a 100 μm-thick ZEONOR film (manufactured by ZEON CORPORATION) using a No. 3 coil bar, dried at 80° C. for 2 minutes, and then subjected to UV curing in a nitrogen atmosphere to form an antifouling layer. The target antifouling film was thereby obtained.

### (Chemical Composition of Resin Composition)

Bifunctional acrylate having a structure represented by the formula (19) below: 9.4525% by mass

Monofunctional methacrylate having a structure represented by the formula (20) below: 0.0475% by mass

IRGACURE-184 (photopolymerization initiator manufactured by BASF Japan Ltd.): 0.5% by mass

Solvent (methyl isobutyl ketone): 90% by mass

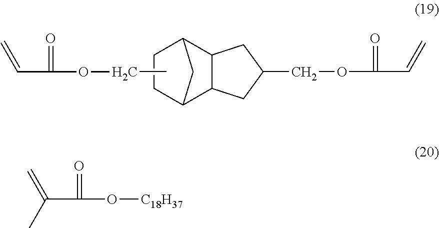

### Example 9

A resin composition having a chemical composition shown below was applied to a 100 μm-thick ZEONOR film (manufactured by ZEON CORPORATION) using a No. 3 coil bar, dried at 80° C. for 2 minutes, and then subjected to UV curing in a nitrogen atmosphere to form an antifouling layer. The target antifouling film was thereby obtained.

### (Chemical Composition of Resin Composition)

Bifunctional acrylate having a structure represented by the formula (21) below: 9.405% by mass

Monofunctional methacrylate having a structure represented by the formula (22) below: 0.095% by mass

IRGACURE-184 (photopolymerization initiator manufactured by BASF Japan Ltd.): 0.5% by mass

Solvent (methyl isobutyl ketone): 90% by mass

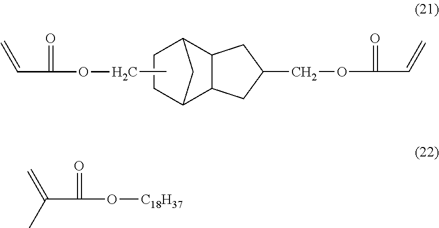

### Example 10

A resin composition having a chemical composition shown below was applied to a 100 μm-thick ZEONOR film (manufactured by ZEON CORPORATION) using a No. 3 coil bar, dried at 80° C. for 2 minutes, and then subjected to UV curing in a nitrogen atmosphere to form an antifouling layer. The target antifouling film was thereby obtained.

### (Chemical Composition of Resin Composition)

Bifunctional acrylate having a structure represented by the formula (23) below: 9.31% by mass

Monofunctional methacrylate having a structure represented by the formula (24) below: 0.19% by mass

IRGACURE-184 (photopolymerization initiator manufactured by BASF Japan Ltd.): 0.5% by mass

Solvent (methyl isobutyl ketone): 90% by mass

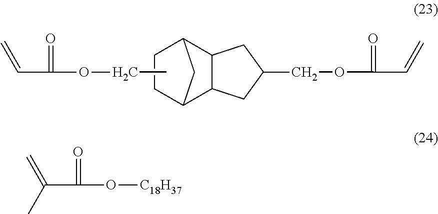

### Example 11

A resin composition having a chemical composition shown below was applied to a 100 μm-thick ZEONOR film (manufactured by ZEON CORPORATION) using a No. 3 coil bar, dried at 80° C. for 2 minutes, and then subjected to UV curing in a nitrogen atmosphere to form an antifouling layer. The target antifouling film was thereby obtained.

### (Chemical Composition of Resin Composition)

Bifunctional acrylate having a structure represented by the formula (25) below: 9.4525% by mass

Monofunctional methacrylate having a structure represented by the formula (26) below: 0.0475% by mass

IRGACURE-184 (photopolymerization initiator manufactured by BASF Japan Ltd.): 0.5% by mass

Solvent (methyl isobutyl ketone): 90% by mass

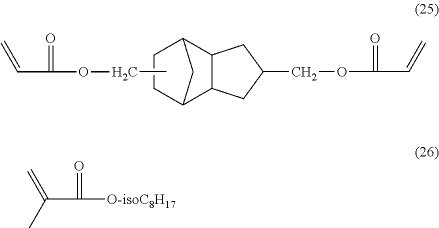

### Example 12

A 1.3 mm-thick glass slide (manufactured by Matsunami Glass Ind., Ltd.) was dipped into a resin composition having a chemical composition shown below at room temperature for 2 hours. Then the glass slide was rinsed with acetone and dried at 80° C. for 2 minutes, and the resin composition was cured at 150° C. for 2 hours. The target antifouling film was thereby obtained.

### (Chemical Composition of Resin Composition)

Compound having a structure represented by the formula (27) below: 1% by mass

Compound having a structure represented by the formula (28) below: 1% by mass

Solvent (acetone): 98% by mass

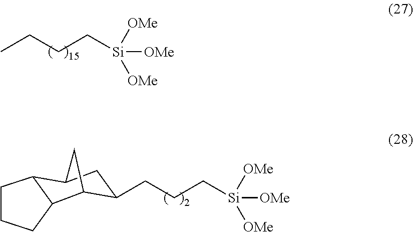

### (Evaluation of Dynamic Contact Angles)

The dynamic contact angles were evaluated as in Examples 1 to 4 and Comparative Examples 1 and 2 described above. The results are shown in TABLE 2.

### (Evaluation of Ease of Wiping Off Fingerprints)

The ease of wiping off fingerprints with a finger was evaluated as in Examples 1 to 4 and Comparative Examples 1 and 2 described above. The results are shown in TABLE 2.

TABLE 2 shows the evaluation results in Examples 5 to 12.

TABLE 2

| | | | | | Ease of |
|---|---|---|---|---|---|
| | | | | | Wiping |
| | Structure of Surface | | | | Off |
| | Hydrocarbon Group | | | | Finger- |
| | | Chain | | | prints |
| | | Hydro- | Advancing | Receding | with |
| | | carbon | Contact | Contact | Finger |
| | Ring System | Group | Angle (°) | Angle (°) | (°) |
| Example 5 | Unsaturated | No | 13.1 | 7.6 | 3 |
| Example 6 | Saturated | No | 12 | 6.7 | 3 |
| Example 7 | Saturated | Yes | 11.5 | 6.2 | 4 |
| Example 8 | Saturated | Yes | 9.8 | 4.5 | 4 |
| Example 9 | Saturated | Yes | 10.9 | 5.5 | 4 |
| Example 10 | Saturated | Yes | 11.3 | 6 | 4 |
| Example 11 | Saturated | Yes | 11.2 | 5.7 | 4 |
| Example 12 | Saturated | Yes | 10 | 4.7 | 4 |

### (Discussion)

The following can be seen from TABLE 2.

In Examples 5 and 6, since a compound having a cyclic hydrocarbon group was contained in the surface, the dynamic contact angles of oleic acid were low, and favorable wipeability was obtained.

In Examples 7 to 10, since both a compound having a cyclic hydrocarbon group and a compound having a chain hydrocarbon group at one terminal end were contained in the surface, the dynamic contact angles of oleic acid were low, and favorable wipeability was obtained.

In Example 11, a compound having a branched chain hydrocarbon group was contained in the surface. Even in this case, the same effects as those in Examples 7 to 10 were obtained.

In Example 12, a silane coupling agent containing both a compound having a cyclic hydrocarbon group and a compound having a chain hydrocarbon group at one terminal end was contained in the surface. Even in this case, the same effects as those in Examples 7 to 10 were obtained.

The reason that the use of a combination of a compound having a cyclic hydrocarbon group and a compound having a chain hydrocarbon group further improves the ease of wiping off fingerprints is not clear, but the reason may be as follows. The moiety of the cyclic hydrocarbon group is relatively large, and small gaps may be present between the cyclic hydrocarbon groups after the fingerprint resistant surface is formed. Since no atoms are present in these gaps, almost no intermolecular force acts on fingerprint components in these gaps, so that these gaps cannot attract the fingerprint components. Therefore, when a combination of a compound having a cyclic hydrocarbon group and a compound having a chain hydrocarbon group is used, part of chain hydrocarbon groups enter the gaps between the cyclic hydrocarbon groups, and the gaps can thereby be filled. Therefore, the force attracting the components of fingerprints on the fingerprint resistant surface increases, and this may improve the ease of wiping off fingerprints.

As described above, even when a compound having a cyclic hydrocarbon group is contained in the surface, favorable wipeability is obtained, as in the case in which a compound having an ester linkage is contained in the surface as described above.

When both a compound having a cyclic hydrocarbon group and a compound having a chain hydrocarbon group are contained in the surface, better wipeability is obtained as compared to that when only one of a compound having a cyclic hydrocarbon group and a compound having an ester linkage is contained in the surface.

### 3. Dynamic Contact Angles

### Comparative Example 3

A resin composition having a chemical composition shown below was applied to an 80 μm-thick TAC film (manufactured by Fujifilm Corporation) using a No. 3 coil bar and dried at 80° C. for 2 minutes to form a coating layer on the TAC film. The target antifouling film was thereby obtained.

### (Chemical Composition of Resin Composition)

Cellulose triacetate (manufactured by Wako Pure Chemical Industries, Ltd.): 10% by mass

Solvent (methylene chloride): 90% by mass

### Comparative Example 4

A resin composition having a chemical composition shown below was applied to an 80 μm-thick TAC film (manufactured by Fujifilm Corporation) using a No. 3 coil bar and dried at 150° C. for 30 minutes to form a coating layer on the TAC film. The target antifouling film was thereby obtained.

### (Chemical Composition of Resin Composition)

Polyamide-imide (product name: HR-11NN, manufactured by TOYOBO CO., LTD.): 10% by mass

Solvent (N-methyl-2-pyrrolidone (NMP)): 90% by mass

### Comparative Example 5

A resin composition having a chemical composition shown below was applied to an 80 μm-thick TAC film (manufactured by Fujifilm Corporation) using a No. 3 coil bar, dried at 80° C. for 2 minutes, and then subjected to UV curing in a nitrogen atmosphere to form a coating layer on the TAC film. The target antifouling film was thereby obtained.

### (Chemical Composition of Resin Composition)

Urethane acrylate (product name: CN9006, manufactured by SARTOMER JAPAN INC.: 9.5% by mass

Photopolymerization initiator (product name: IRGACURE-184, manufactured by BASF Japan Ltd.): 0.5% by mass

Solvent (t-butanol): 90% by mass

Next, “evaluation of dynamic contact angles” and “evaluation of ease of wiping off fingerprints” were performed on the surface of each of the above films as follows.

### (Evaluation of Dynamic Contact Angles)

The dynamic contact angles of oleic acid were evaluated as in Examples 1 to 4 and Comparative Examples 1 and 2 described above. The results are shown in TABLE 3.

### (Evaluation of Ease of Wiping Off Fingerprints)

The ease of wiping off fingerprints was evaluated as in Examples 1 to 4 and Comparative Examples 1 and 2 described above. The results are shown in TABLE 3.

TABLE 3 shows the evaluation results in Comparative Examples 3 to 5.

TABLE 3

| | | Advancing | Receding | | |
|---|---|---|---|---|---|
| | Coating | Contact Angle | Contact Angle | Ease of Wiping Off | |
| | Material | (°) | (°) | Fingerprints with Finger | Surface Structure |
| Comparative | Cellulose | 15.4 | 12.9 | 1 | Cellulose Based (Ester |
| Example 3 | Triacetate | | | | Linkages at Terminal Ends of |
| | | | | | Side Chains) |
| Comparative | Polyamide- | 20 | 12.7 | 1 | Polyamide-Imide (Amide Bond |
| Example 4 | Imide | | | | in Main Chain) |
| Comparative | Ultraviolet | 16.9 | 15.7 | 1 | Urethane Acrylate (Urethane |
| Example 5 | Ray-Curable | | | | Bond in Main Chain) |
| | Urethane | | | | |
| | Acrylate | | | | |

### (Discussion)

In comprehensive consideration of the evaluation results shown in TABLEs 1 to 3, the following can be found about the dynamic contact angles of oleic acid and the molecular structure of the material of the antifouling layer.

### (Dynamic Contact Angles of Oleic Acid)

When the advancing contact angle of oleic acid is 15° or less and the receding contact angle is 10° or less, excellent wipeability is obtained, and fingerprints adhering to the evaluation surface become almost unnoticeable by simply rubbing the adhering fingerprints with a finger.

### (Molecular Structure of Material of Antifouling Layer)

In Examples 1 to 12, a material having, in its molecule, an ester linkage or a cyclic hydrocarbon group (a saturated cyclic hydrocarbon group or an unsaturated cyclic hydrocarbon group) is used as the material of the antifouling layer. In such an antifouling layer, the dynamic contact angles of oleic acid on the surface of the antifouling layer are small, so that favorable wipeability is obtained.

In Comparative Example 3, a material having ester linkages in its molecule (cellulose triacetate) is used as the material of the antifouling layer. However, the dynamic contact angles of oleic acid on the surface of the antifouling layer are large, and favorable wipeability is not obtained. This may be because the ester linkages are present at terminal ends of side chains.

In Comparative Examples 4 and 5, a material having, in its molecule, an amide bond or a urethane bond (polyamide-imide or urethane acrylate) is used as the material of the antifouling layer. In such an antifouling layer, the dynamic contact angles of oleic acid on the surface of the antifouling layer are large, and favorable wipeability is not obtained.

In comprehensive consideration of the above evaluation results, it is found that there is a correlation between the ease of wiping off fingerprints and the dynamic contact angles of oleic acid and that the ease of wiping off fingerprints can be improved when the advancing contact angle of oleic acid on the surface is 15° or less and the receding contact angle of oleic acid is 10° or less.

It is also found that a surface with the dynamic contact angles falling within the above value ranges can be obtained when a compound having an ester linkage in a portion other than terminal ends or a compound having a cyclic hydrocarbon group is contained in the surface.

### 4. Surface Having Groove Shape

### Example 13

First, a Cr (chromium) layer was evaporated onto a glass substrate with φ150 mm (AN100 material, manufactured by ATOCK Inc.) to a thickness of 1 μm. Then the Cr layer was spin-coated with a photoresist (manufactured by AZ Electronic Materials), and the resultant substrate was pre-baked at 100° C. for 2 minutes. A photoresist layer having a thickness of about 1 μm was thereby formed.

Next, the formed photoresist layer was exposed to light using a patterned chromium glass mask. Then the photoresist layer exposed to light was developed using AZ300MIF (manufactured by AZ Electronic Materials), and post-baking was performed at 110° C. for 2 minutes. Next, the chromium layer was etched for 5 minutes using a Cr etchant (product name: 11N, manufactured by Nagase ChemteX Corporation).

Next, the photoresist layer was treated with a stripping solution (product name: 106, manufactured by TOKYO OHKA KOGYO Co., Ltd.) at 80° C. for 5 minutes to strip the photoresist layer from the etched Cr layer. Next, the glass substrate with the photoresist layer stripped was spin-coated with a water-repellent (product name: KP-801, manufactured by Shin-Etsu Chemical Co., Ltd.) to perform release treatment. A glass substrate (mold) having a transfer pattern on one principal surface was thereby obtained. Next, a resin composition having a chemical composition shown below was applied to a PET substrate (product name: O300E, manufactured by Mitsubishi plastic Inc.), and the transfer pattern on the glass substrate used as a mold was UV-transferred to the resin composition to thereby form an antifouling layer having grid-like grooves (FIG. 9B) on its surface. The pitch P of the grid-like grooves was 100 μm, their width W was 10 μm, and the depth D was 0.9 μm. The target antifouling film was thereby obtained.

### (Chemical Composition of Resin Composition)

Resin having a structure represented by the formula (29) below: 95% by mass

IRGACURE-184 (photopolymerization initiator manufactured by BASF Japan Ltd.): 5% by mass

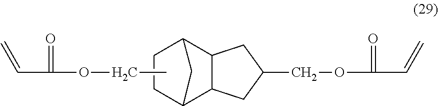

### (Shape Evaluation)

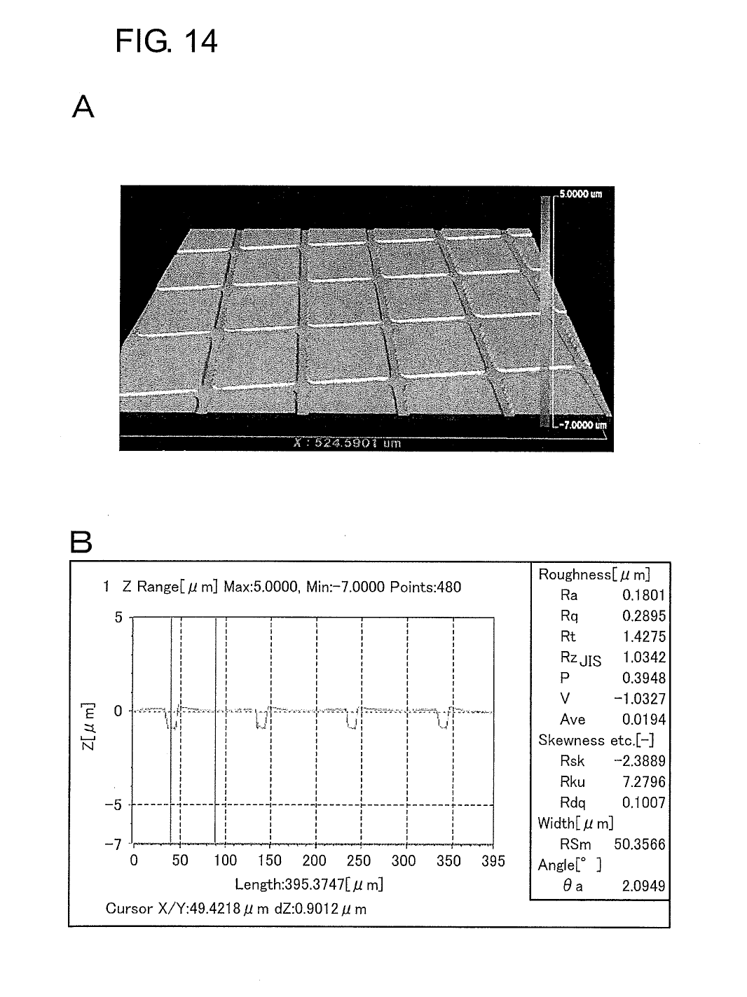

The surface shape of the thus-obtained antifouling film in Example 13 was checked using a laser microscope. The results are shown in FIG. 14A.

### (Evaluation of Dynamic Contact Angles)

The dynamic contact angles were evaluated as in Examples 1 to 4 and Comparative Examples 1 and 2 described above. The results are shown in TABLE 4.

TABLE 4 shows the evaluation results in Example 13. TABLE 4 also shows the evaluation results in Example 6, for comparison of the evaluation results.

TABLE 4

| | Structure of Surface | | | | | Ease of |
|---|---|---|---|---|---|---|
| | Hydrocarbon Group | | | | Receding | Wiping Off |
| | | Chain | | Advancing | Contact | Fingerprints |
| | Ring | Hydrocarbon | Surface | Contact | Angle | with |
| | System | Group | Shape | Angle (°) | (°) | Finger |
| Example 13 | Saturated | No | Grid- | 9.7 | 4.7 | 4 |
| | | | like | | | |
| | | | Grooves | | | |
| Example 6 | Saturated | No | Flat | 12 | 6.7 | 3 |
| | | | Surface | | | |

### (Discussion)

The following can be seen from TABLE 4.

In Example 6, a flat surface is formed using a resin composition having a cyclic hydrocarbon group, and the receding contact angle can be reduced to 6.7°.

In Example 13, a surface having grid-like grooves is formed using the same resin composition as that in Example 6, and the receding contact angle can be further reduced to 4.7°. that is lower than that in Example 6.

Therefore, it is preferable that, to further reduce the dynamic contact angles to thereby further improve the ease of wiping off fingerprints, recesses such as grooves be formed on the surface of the antifouling layer.

The embodiments and Examples of the present technique have been specifically described above. However, the present technique is not limited to the above embodiments and Examples, and various modifications can be made on the basis of the technical idea of the present technique.

For example, the configurations, methods, processes, shapes, materials, values, etc. described in the above embodiments and Examples are merely examples, and configurations, methods, processes, shapes, materials, values, etc. different from those described above may be used as needed.

The configurations, methods, processes, shapes, materials, values, etc. in the above embodiments may be mutually combined so long as the combination does not depart from the gist of the present technique.

In addition, the present technique may be configured as follows.

(1) An antifouling substrate, including

a substrate having a surface, and

an antifouling layer provided on the surface of the substrate, wherein

the antifouling layer contains at least one of a first compound having an ester linkage in a portion other than terminal ends and a second compound having a cyclic hydrocarbon group,

an advancing contact angle of oleic acid on a surface of the antifouling layer is 15° or less, and

a receding contact angle of oleic acid on the surface of the antifouling layer is 10° or less.

(2) The antifouling substrate according to (1), wherein the antifouling layer has a surface on which a recess is provided.

(3) The antifouling substrate according to (2), wherein the recess generates positive capillary pressure acting on a liquid present on the surface of the antifouling layer.

(4) The antifouling substrate according to (2) or (3), wherein

a width W of the recess is within the range of 1 nm or more and 1 mm or less, and

a depth D of the recess is within the range of 1 nm or more and 1 mm or less.

(5) The antifouling substrate according to any of (1) to (4), wherein the at least one of the first compound and the second compound is adsorbed on the surface of the substrate.

(6) The antifouling substrate according to any of (1) to (5), wherein the antifouling layer is a monomolecular layer containing the at least one of the first compound and the second compound.

(7) The antifouling substrate according to any of (1) to (6), wherein the antifouling layer is a coating layer.

(8) The antifouling substrate according to (7), wherein

the coating layer contains at least one of an energy ray-curable resin composition and a thermosetting resin composition, and

the energy ray-curable resin composition and the thermosetting resin composition each contain the at least one of the first compound and the second compound.

(9) The antifouling substrate according to (7) or (8), wherein the first compound and the second compound are each an additive.

(10) The antifouling substrate according to (9), wherein the additive is a leveling agent.

(11) The antifouling substrate according to any of (1) to (10), wherein, when the antifouling layer contains the second compound, the antifouling layer further contains, together with the second compound, a third compound having a chain hydrocarbon group at a terminal end.

(12) The antifouling substrate according to any of (1) to (11), wherein

the first compound is represented by the formula (1) or (2) below, and

the second compound is represented by the formula (3) or (4) below,

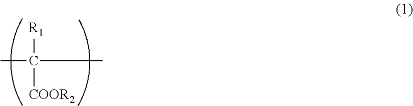

wherein, in the formula (1), R₁ is a group containing any of C, N, S, O, Si, P, and Ti, and R₂ is a group having 2 or more carbon atoms,

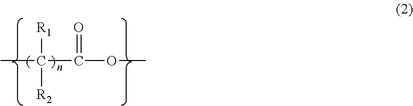

wherein, in the formula (2), R₁ and R₂ are each independently a group containing any of C, N, S, O, Si, P, and Ti.

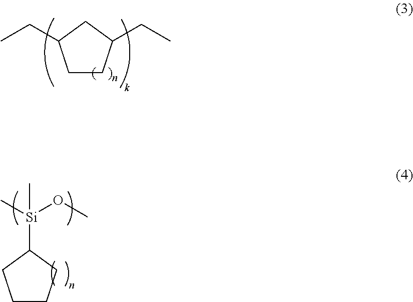

(13) The antifouling substrate according to (12), wherein R₁ and R₂ in the formulas (1) and (2) above are each independently a hydrocarbon group, a sulfo group, a sulfonyl group, a sulfonamide group, a carboxylic acid group, an amino group, an amide group, a phosphoric acid group, a phosphino group, a silanol group, an epoxy group, an isocyanate group, a cyano group, a thiol group, or a hydroxyl group.

(14) The antifouling substrate according to (11), wherein the third compound is represented by the formula (5) or (6) below.

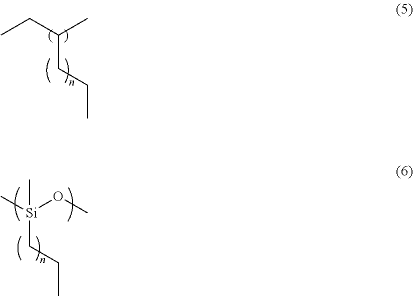

(15) An input device, including

an input surface and an antifouling layer provided thereto, wherein,

the antifouling layer contains at least one of a first compound having an ester linkage in a portion other than terminal ends and a second compound having a cyclic hydrocarbon group,

an advancing contact angle of oleic acid on a surface of the antifouling layer is 15° or less, and

a receding contact angle of oleic acid on the surface of the antifouling layer is 10° or less.

(16) A display device, including

a display surface and an antifouling layer provided thereto, wherein

the antifouling layer contains at least one of a first compound having an ester linkage in a portion other than terminal ends and a second compound having a cyclic hydrocarbon group,

an advancing contact angle of oleic acid on a surface of the antifouling layer is 15° or less, and

a receding contact angle of oleic acid on the surface of the antifouling layer is 10° or less.

(17) An antifouling layer, including

at least one of a first compound having an ester linkage in a portion other than terminal ends and a second compound having a cyclic hydrocarbon group, wherein

an advancing contact angle of oleic acid on a surface of the antifouling layer is 15° or less, and

a receding contact angle of oleic acid on the surface of the antifouling layer is 10° or less.

### REFERENCE SIGNS LIST

1 substrate
1a recess
2 antifouling layer
2a recess
2a adsorption compound
3 anchor layer
4 hard coating layer
101 display device
102 input device
103 front panel
S fingerprint resistant surface (antifouling surface)
S₁ display surface
S₂ input surface
S₂ panel surface
θa advancing contact angle
θr receding contact angle

1. An antifouling substrate, comprising
a substrate having a surface, and
an antifouling layer provided on the surface of the substrate, wherein
the antifouling layer contains at least one of a first compound having an ester linkage in a portion other than terminal ends and a second compound having a cyclic hydrocarbon group,
the at least one of the first compound and the second compound is adsorbed on the surface of the substrate,
an advancing contact angle of oleic acid on a surface of the antifouling layer is 15° or less, and
a receding contact angle of oleic acid on the surface of the antifouling layer is 10° or less.

2. An antifouling substrate, comprising
a substrate having a surface, and
an antifouling layer provided on the surface of the substrate, wherein
the antifouling layer contains at least one of a first compound having an ester linkage in a portion other than terminal ends and a second compound having a cyclic hydrocarbon group,
the first compound is represented by the formula (1) or (2) below,
the second compound is represented by the formula (3) or (4) below,
an advancing contact angle of oleic acid on a surface of the antifouling layer is 15° or less, and
a receding contact angle of oleic acid on the surface of the antifouling layer is 10° or less, 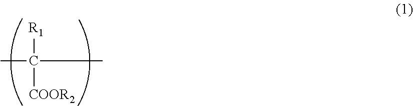
wherein, in the formula (1), R₁ is a group containing any of C, N, S, O, Si, P, and Ti, and R₂ is a group having 2 or more carbon atoms, 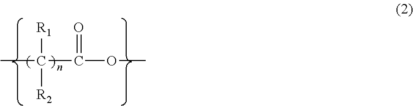
wherein, in the formula (2), R₁ and R₂ are each independently a group containing any of C, N, S, O, Si, P, or Ti.

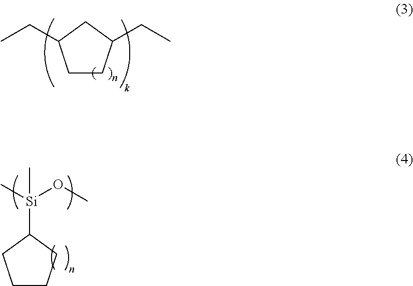

3. An antifouling substrate, comprising
a substrate having a surface, and
an antifouling layer provided on the surface of the substrate, wherein
the antifouling layer contains at least one of a first compound having an ester linkage in a portion other than terminal ends and a second compound having a cyclic hydrocarbon group,
the antifouling layer further contains, together with the second compound, a third compound having a chain hydrocarbon group at a terminal end,
the third compound is represented by the formula (5) or (6) below,
an advancing contact angle of oleic acid on a surface of the antifouling layer is 15° or less, and
a receding contact angle of oleic acid on the surface of the antifouling layer is 10° or less.

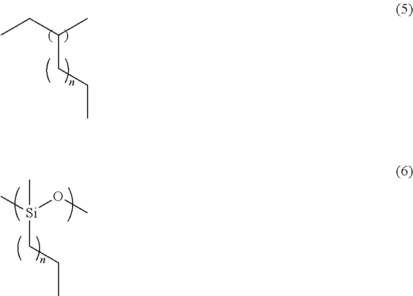

4. The antifouling substrate according to claim 1, wherein the antifouling layer has a surface on which a recess is provided.

5. The antifouling substrate according to claim 4, wherein the recess generates positive capillary pressure acting on a liquid present on the surface of the antifouling layer.

6. The antifouling substrate according to claim 4, wherein
a width W of the recess is within a range of 1 nm or more and 1 mm or less, and
a depth D of the recess is within a range of 1 nm or more and 1 mm or less.

7. The antifouling substrate according to claim 1, wherein the antifouling layer is a monomolecular layer containing the at least one of the first compound and the second compound.

8. The antifouling substrate according to claim 1, wherein the antifouling layer is a coating layer.

9. The antifouling substrate according to claim 8, wherein
the coating layer contains at least one of an energy ray-curable resin composition and a thermosetting resin composition, and
the energy ray-curable resin composition and the thermosetting resin composition each contain the at least one of the first compound and the second compound.

10. The antifouling substrate according to claim 8, wherein the first compound and the second compound are each an additive.

11. The antifouling substrate according to claim 10, wherein the additive is a leveling agent.

12. The antifouling substrate according to claim 2, wherein R₁ and R₂ in the formulas (1) and (2) above are each independently a hydrocarbon group, a sulfo group, a sulfonyl group, a sulfonamide group, a carboxylic acid group, an amino group, an amide group, a phosphoric acid group, a phosphino group, a silanol group, an epoxy group, an isocyanate group, a cyano group, a thiol group, or a hydroxyl group.

13. An input device, comprising the antifouling substrate according to claim 1.

14. A display device, comprising the antifouling substrate according to claim 1.

15. An antifouling layer, comprising
at least one of a first compound having an ester linkage in a portion other than terminal ends and a second compound having a cyclic hydrocarbon group, wherein
the at least one of the first compound and the second compound is adsorbed on a surface of the substrate,
an advancing contact angle of oleic acid on a surface of the antifouling layer is 15° or less, and
a receding contact angle of oleic acid on the surface of the antifouling layer is 10° or less.

16. An antifouling layer, comprising
at least one of a first compound having an ester linkage in a portion other than terminal ends and a second compound having a cyclic hydrocarbon group, wherein
the first compound is represented by the formula (1) or (2) below,
the second compound is represented by the formula (3) or (4) below,
an advancing contact angle of oleic acid on a surface of the antifouling layer is 15° or less, and
a receding contact angle of oleic acid on the surface of the antifouling layer is 10° or less, 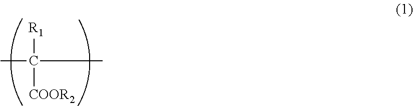
wherein, in the formula (1), R₁ is a group containing any of C, N, S, O, Si, P, and Ti, and R₂ is a group having 2 or more carbon atoms, 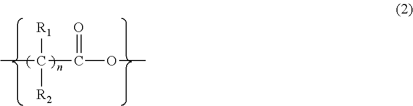
wherein, in the formula (2), R₁ and R₂ are each independently a group containing any of C, N, S, O, Si, P, and Ti.

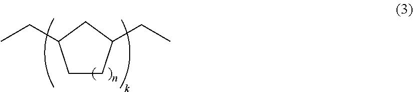

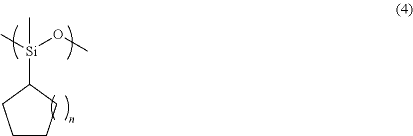

17. An antifouling layer, comprising
at least one of a first compound having an ester linkage in a portion other than terminal ends and a second compound having a cyclic hydrocarbon group, wherein
when the antifouling layer includes the second compound, the antifouling layer further includes, together with the second compound, a third compound having a chain hydrocarbon group at a terminal end,
the third compound is represented by the formula (5) or (6) below,
an advancing contact angle of oleic acid on a surface of the antifouling layer is 15° or less, and
a receding contact angle of oleic acid on the surface of the antifouling layer is 10° or less. [chemical structure]
